(19) United States
(12) Patent Application Publication
(10) Pub. No.: US 2009/0289844 A1
(43) Pub. Date: Nov. 26, 2009

(54) POSITION MONITORING SYSTEM

(75) Inventors: Boyd Palsgrove, Maple Grove, MN (US); Mark R. Mitchell, Blaine, MN (US)

Correspondence Address: SCHWEGMAN, LUNDBERG & WOESSNER, P.A., P.O. BOX 2938, MINNEAPOLIS, MN, 55402, US

(73) Assignee: White Bear Technologies, New Brighton, MN (US)

(21) Appl. No.: 12/470,077

(22) Filed: May 21, 2009

Related U.S. Application Data
(60) Provisional application No. 61/055,918, filed on May 23, 2008.
(60) Provisional application No. 61/195,222, filed on Oct. 3, 2008.

(51) Int. Cl. G01S 5/00

(52) U.S. Cl. 342/357.07

(57) ABSTRACT

Various embodiments include a system comprising a remote unit operable to determine a geographic location of the remote unit, and to transmit data indicating the location of the remote unit, the remote unit coupled to a subject to be tracked, the remote unit operable to provide a stimulation to the subject, and a base unit operable receive the data indication the location of the remote unit, to determine if the remote unit is within a defined perimeter, and to signal the remote unit to provide the stimulation to the subject if the remote unit is not within the defined perimeter.

### CROSS-REFERENCE TO RELATED APPLICATIONS

The present application claims the benefit of the filing date of U.S. provisional application Ser. No. 61/055,918 filed May 23, 2008, and the benefit of the filing date of U.S. provisional application Ser. No. 61/195,222, filed Oct. 3, 2008, the disclosures of which are each incorporated by reference herein.

### BACKGROUND

Parents and others responsible for supervising the activities of children may sometimes find it difficult to ensure that such children do not wander away if playing outdoors. In addition, it is also sometimes difficult to keep a pet, such as a dog, within a desired area in the absence of a fence or wall enclosing the area. Accordingly, there is a need for systems, methods, and devices to reduce these difficulties.

### BRIEF DESCRIPTION OF THE DRAWINGS

FIG. 1 is a block diagram of a portable position monitoring system;

FIG. 2A illustrates various embodiments of a base unit including a portable base unit having a visual display;

FIG. 2B illustrates various embodiments of a base unit including a portable base unit having a visual display;

FIG. 3A illustrates a visual display provided by a visual display of a base unit;

FIG. 3B illustrates another visual display provided by a visual display unit of a base unit;

FIG. 3C illustrates still another visual display provided by a visual display of a base unit;

FIG. 4 illustrates a base unit used in a fence definition mode;

FIG. 5 illustrates a particular implementation of the positional monitoring system including a pet collar;

FIG. 6 illustrates a pet location monitoring system according to various embodiments;

FIG. 7A illustrates an illustrative set of zone configurations according to various embodiments;

FIG. 7B illustrates an illustrative exclusion zone and base unit according to various embodiments;

FIG. 8A illustrates a positional monitoring system according to various embodiments;

FIG. 8B illustrates another positional monitoring system according to various embodiments;

FIG. 8C illustrates another positional monitoring system according to various embodiments;

FIG. 8D illustrates a diagram including a map indicating a position for a remote unit;

FIG. 8E illustrates various embodiments of a fencing mode;

FIG. 8F illustrates various embodiments of a fencing mode;

FIG. 9 illustrates one or more of Operational Modes 900 of a base unit; and

FIG. 10 illustrates application modules of a base unit.

### DETAILED DESCRIPTION OF THE EMBODIMENTS

In the following detailed description of exemplary embodiments, reference is made to the accompanying drawings that form a part hereof, and in which is shown by way of illustration specific exemplary embodiments which may be practiced. These embodiments are described in sufficient detail to enable those skilled in the art to practice the various embodiments, and it is to be understood that other embodiments may be utilized and that logical, mechanical, electrical and other changes may be made without departing from the scope of this disclosure. The following detailed description is, therefore, not to be taken in a limiting sense.

The following embodiments and others may be implemented in one or a combination of hardware, firmware and software. Embodiments may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

In the Figures, the same reference number is used throughout to refer to an identical component which appears in multiple Figures. Signals and connections may be referred to by the same reference number or label, and the actual meaning may be clear from its use in the context of the description.

According to one example embodiment of the inventive subject matter, there is disclosed a method and apparatus to allow a user to locate and track a number objects. In one example embodiment of the inventive subject matter GPS and RF technology are used to capture and report the coordinates of the remote tracked units to a central base unit that may in one embodiment be portable. Optionally, the base unit may have a fixed or stationary location The user may be presented with the location information on a LCD screen.

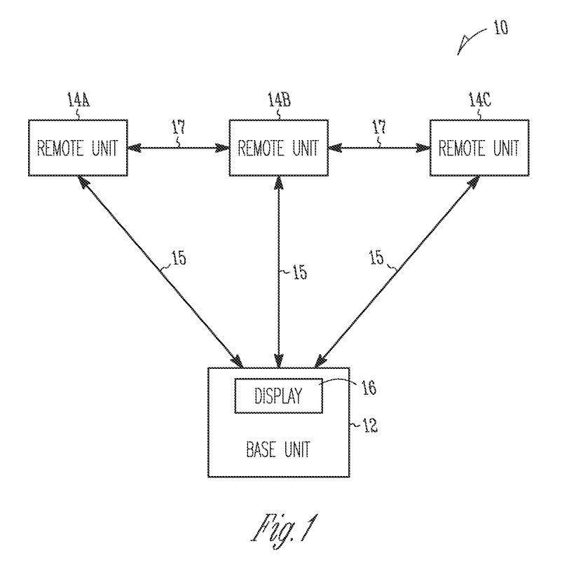

FIG. 1 is a block diagram of a portable position monitoring system 10. In various embodiments, positional monitoring system 10 includes a portable base unit 12 and one or more portable remote units 14 that are each communicatively linked to the base unit 12 through a wireless communication link 15. In various embodiments, of the remote units 14 and the base unit 12 are GPS-enabled transceivers that transmit and receive signals from GPS satellites in a conventional manner so as to operably obtain and provide a geographical location for each of the remote units 14 and the base unit 12. According to some embodiments of the inventive subject matter, however, only the remote units 14 are GPS-enabled transceivers, with the base unit 12 optionally being preprogrammed to represent designated locations or boundaries. According to various embodiments, the base unit is fixed in position, such as in a home.

In various embodiments, one or more of remote units 14 is operable to obtain and provide a geographical location for the so operable remote unit 14 based on dead reckoning navigation capabilities.

According to various embodiments, the remote units 14 periodically or continuously transmit their respective GPS-identified location to the base unit 12 through wireless communication techniques including, for example, direct radio frequency transmissions. In various embodiments, one or more of remote units 14 periodically or continuously transmit their receptive locations to the base unit 12 through wireless communication techniques, the locations based on dead reckoning navigational techniques.

Such a wireless communication technique enables the system 10 to be fully independent of a separate and distinct network communication system. In various embodiments, positional information for one or more of remote units 14 is communicated to base unit 12 using communication link 15.

Through the self-contained network of the system 10, the base unit 12 is able to track the location, preferably the absolute position, of each of the remote units 14. In embodiments, wherein the base unit 12 is GPS-enabled to obtain its own geographical location, the base unit 12 can additionally track the positions of each of remote units 14 communicatively linked to the base unit 12 in the system 10 relative to one another and/or relative to the base unit 12. As such, the absolute and/or relative positions of each of the remote units in system 10 may be computed by the base unit 12, and displayed in a visual display 13 incorporated with the base unit 12. In various embodiments, the display provided at visual display 16 uniquely identifies each of the remote units 14 within the system 10, such that a user may readily discern the location and identity of each of the remote units 14 within the system 10. A variety of tracking and display options are contemplated as being useful in the visual display 16 portion of base unit 12. In various embodiments, system 10 includes more than one base unit 12.

System 10 as shown in FIG. 1 includes a plurality of remote units 14. However, the number of remote units is not limited to a particularly number of remote units. It would be understood that system 10 in some embodiments would include a single remote unit 14 and a base station 12. In various embodiments, system 10 includes up to some maximum number of remote units. In various embodiments, system 10 includes eight remote units. However, the maximum number of remote units that are operable in conjunction with a base unit 12 is not limited to any particular number.

In various embodiments, one or more of remote units 14 are communicatively linked to another one of the remote units 14 through wireless communicative link 17. In various embodiments, wireless communication link 17 is a same type of communication link as communication link 15. In various embodiments, wireless communication link 17 is a different type of communication link as communication link 15. In various embodiments, communication link 15 and 17 are a same type of communication link, but operate at different carrier frequencies, the carrier frequency being a frequency or range of frequencies used as a carrier wave for the information being communicated between a given remote unit 14 and the base nit 12 or between different remote units 14.

In accordance with various embodiments of the inventive subject matter, the remote units 14 are capable of transmitting location information directly to the base unit 12 over a range of several kilometers. In fact, the system 10 may be capable of simultaneously tracking the positions of one or more units within system 10, wherein such units are, for example, up to 25 km apart from one another. It is contemplated, however, that such a range may be greater if the technology and power so permit. To obtain a range of up to about 25 km, the remote units 14 may transmit radio frequency wave forms at a power of at least about 2 watts. Such remote units 14, therefore, incorporate internal amplification mechanisms to generate the power necessary to carry a signal over many kilometers to the base unit 12. It is also contemplated that such range may be extended by relaying the GPS location information through intermediate transmittal receivers, or through a mobile telephone or data network.

The power required to generate the above-described signal can create significant drain upon the portable energy sources incorporated with the remote units 14. Accordingly, it is a further aspect of an embodiment to incorporate energy saving mechanisms in such remote units 14 to save as much power as possible in reserve for any necessary long-range communications to the base unit 12. For example, the remote units 14 may only intermittently transmit location information to the base unit 12. Such intermittent communication may be designated by the user to occur only at selected times. As such, the communication between the remote units 14 and the base unit 12 may be automatically or manually generated, as is desired per application.

In some embodiments of the inventive subject matter, the remote units 14 are configured to receive direct communication from the base unit 12 and/or other remote units 14 within the system 10. As such, it is contemplated that each remote unit 14 within the system 10 may be configured to transmit their own respective GPS-identified location to at least selected ones of the remaining remote units 14 in the system 10, as well as to receive like information from such other remote units 14 in system 10, so that each remote unit 14 within the system 10 is able to track the positions of selected ones of every remote unit 14 within the system 10. To facilitate such tracking, the remote units 14 may further include a visual display similar to that described above with reference to the display 16 on the base unit 12. In some embodiments of the inventive subject matter, the base unit 12 itself may be configured for transmission of its GPS-identified location to the remaining remote units 14 within the system 10.

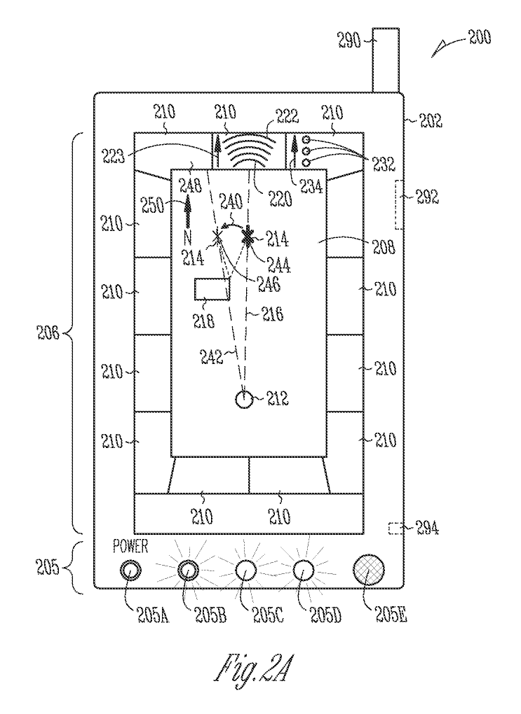

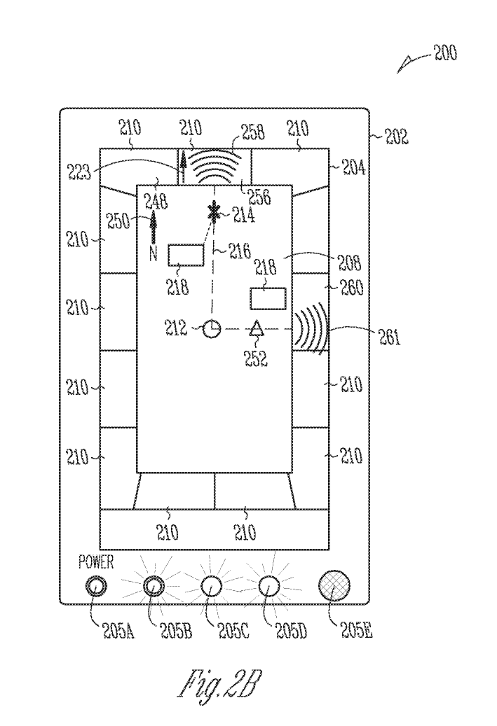

FIG. 2A illustrates various embodiments of a base unit 200 including a portable base unit 202 having a visual display 204. In various embodiments, portable base unit 202 is the base unit 12 as shown in FIG. 1. As shown in FIG. 2A, visual display 204 includes a viewable area 206. In various embodiments, viewable area 206 includes the area of a visual display screen that is operable to be controlled so as to provide a particular combination of visual images within the viewable area 206. In various embodiments, viewable area 206 includes a central screen area 208 surrounded by a plurality of individually controllable indicator segments 210. In various embodiments, individual ones, or various combinations of, the indicator segments 210 are controlled so as to provide a visual indication of the relative location of one or more remote units with respect to the base unit, as described further herein.

In various embodiments, a relative position between a base unit 212 and a remote unit 214 is visually depicted in the central screen area 208. In various embodiments, the base station 212 depicted on central screen area 208 represents a visual depiction of a position of the portable base unit 202 that includes the display on which base unit 212 is being depicted. In various embodiments, remote unit 214 is any remote unit, such as but not limited to any of the remote units 14 as shown in FIG. 1, that is operable to provide positional information regarding the remote unit to the portable base unit.

As shown in FIG. 2A, line 216 represents a directional relationship between base unit 212 and remote unit 214, although it is not necessary for line 216 to appear on the central screen area 208. Line 216, when extended past the depiction of remote unit 214 on the viewable area 206, terminates at segment indicator 220. In various embodiments, when in a given mode where the relative position of remote unit 214 to base unit 212 is being tracked and displayed, indicator segment 220 will provide a visual indication of the directional alignment of base unit 212 and remote unit 214.

The visual indication provided by indicator segment 220 in not limited to any particular type of visual indication. In various embodiments, indicator segment 220 will simply be illuminated, wherein the remaining indicator segments 210 other than indicator segment 220 will not be illuminated. In various embodiments, indicator segment 220 will be displayed as a particular color that is different from the remaining indictor segments 210. By way of illustration, indicator segment 220 is displayed as white or a bright color, and the remaining indicator segments 210 are displayed as a dark color, such as a gray or black.

In various embodiments, indicator segment 220 will be animated in order to provide a visual perception of motion. By way of illustration, in some embodiments, indicator segment 220 will have strobing sets of lines 222 that are animated so as to produce a visual image of motion in the direction indicted by arrow 223. Arrow 223 is not necessarily visually displayed anywhere on the visual display area 206, but is merely indicative of the perceived direction of motion of the animation of indicator segment 220.

In various embodiments, other techniques to produce the visual perception of motion within a given indicator segment are used. By way of illustration, the visual perception of motion is created in an indicator segment such as but not limited to indicator segment 230 by alternatively illuminated a series of shapes 232 in a sequence so as to produce a visual perception of motion in the direction illustrated by arrow 234. Arrow 224 is not necessarily visually displayed anywhere on the visual display area 206, but is merely indicative of the perceived direction of motion of the animation of indicator segment 230.

In various embodiments, each of indicator segments 210 are operable to be illuminated in order to provide a visual perception of motion indicative of a directional alignment between base unit 212 and a remote unit 214.

In various embodiments, as remote unit 214 moves relative to the position of base unit 212, the relative position of remote unit 214 to base unit 212 as depicted on visual display area 208 is updated. This is illustratively depicted in FIG. 2A by arrow 240 representing a change from position 244 to new position 246 by the remote unit 214.

As a result of the movement represented by arrow 240, the extended alignment of line 216 changes, and the new alignment is represented by line 242. The extension of the new alignment represented by line 242 no longer extends to indicative segment 220, and instead extends to indicative segment 248. Based on the new alignment of line 242, indicative segment 220 will no longer be activated to indicate the directional relationship between base unit 212 and remote unit 214. Instead, indicative segment 244 will be activated to indicate the now present directional alignment between base unit 212 and remote unit 214 when the remote unit 214 is at position 246.

In various embodiments, if the portable base unit 202 being depicted on the viewable area 206 as base unit 212 moves relative to the position of the remote unit 214 resulting in the extended alignment between the portable base unit 202 and the remote unit 214 extending to a particular one of the indicative segments 210 that is different from the currently activated indicated segment, the currently activated indicate segment 210 will no longer be activated, and a new indicative segment will be activated to illustrate the now present alignment between the portable base unit 202 and the remote unit 214.

In various embodiments, when the portable base unit 202 moves relative to the position of the remote unit 214, the relative position of the visual depiction of a base unit 212 as shown on the visual display area 206 will remain the same, but any visual indication of the alignment, and any other indications such as relative distance between the portable base unit 202 and the remote unit 214, will be updated to reflect the movement of the portable base unit.

It would be understood that both the portable base station 202 and the remote unit 214 could be moving simultaneously in a same or in different directions relative to each other. In such circumstances, the given one of the indicative segments 210 that is activated to indicate the current alignment between the portable base unit 202 and the remote unit 214 can be updated so that as the movement of either or both the portable base unit 212 and the remote unit 214 occurs, the given one of the indicative segments 210 that is activated indicates the most recent relative position.

In various embodiments, portable base unit 202 has a built in compass capability that allows the portable base unit 202 to know the directional orientation of the portable base unit 202. In various embodiments, a compass indication 250 is visually displayed on the central screen area 208, or in some other location on the viewable area 206.

In various embodiments, additional information 218 is displayed within the viewable area 206. Addition information is not limited to any particular information, and includes but is not limited to a quantity and units indication for a distance between the portable base unit 202 and the remote unit 214. By way of illustration, the additional information includes “57 yards,” wherein the “57” represents a quantity for a distance between the portable base unit 202 and the remote unit 214, and the “yards” represents the units associated with the quantity. The additional information including “57 yards” is displayed on the viewable area 206 as an indication of the distance between the portable base unit 202 and the remote nit 214. In various embodiments, the units to be displayed are configurable, for example but not limited to configurable between English and Metric units. In various embodiments, the units to be displayed are configurable as to size of the unit, for example, inches, feet, yards, and miles. In various embodiments, the desired units and size of the units is selectable by a user.

In various embodiments, additional information 218 includes absolute position information based on longitude and latitude coordinates for either or both the portable base unit 202 and the remote unit 214. In various embodiments, other positional or geographical information is provided in the additional information 218, such as but not limited to time and date information, altitude information, and movement information such as but not limited to velocity information, including instantaneous or average velocities associated with movements of either or both of the portable base unit 212 and the remote unit 214.

In various embodiments, portable base unit 202 includes one or more control/indicator devices 205. Control/indicator devices are not limited to any particular types of devices, or two any particular number of combination of devices.

Various embodiments include any types of devices such as pushbuttons, switches operable to provide and input signals, visual indicators such as lamps or light emitting diodes (LEDs) to provide visual indications, and audio input and audio output devices such s microphones and speakers respectively to provide audio input and output capabilities. In various embodiments, portable base unit 202 includes a power button 205A operable to be actuated to turn the portable base unit 202 on and off. In various embodiments, portable base unit 202 includes additional pushbuttons 205 B operable to provide some type of input to the portable base unit, such as but not limited to a mode select input. In various embodiments, any of pushbuttons 205A and 205B are illuminated type pushbuttons that can be illuminated to indicate a particular condition or state of portable base unit 212, associated with the pushbutton, such as an “on” condition.

In various embodiments, portable base unit 202 includes one or more visual indicators 205C and 205D. Visual indicators 205C and 205D are not limited to any particular type of visual indicators, and include any type or types of visual indicators that provide a visual indication, including but not limited to a indicator providing an illumination at a particular color or colors as an indication of some status or some state of the portable bas unit. In various embodiments, portable base unit 202 includes an audio output device 205E. Audio output device 205E is not limited to any particular type of audio output device, and includes any type of device, including but not limited to a speaker, operable to output audio sound. In various embodiments, audio output device 205E is operable to provide audio output of variable frequency, and for various time durations, and at various volume levels, including but not limited to sounds such as beeps, or any combination of various sounds having various frequencies, various time durations, and various volumes, in order to indicate various types of information.

In various embodiments, base unit 200 includes an attached antenna 290. In various embodiments, base unit 200 includes an antenna jack 294 operable to allow an external antenna to be coupled to base unit 200. In various embodiments, base unit 200 includes one or more pushbuttons 292 located on a side surface of base unit 200.

FIG. 2B illustrates various embodiments of a base unit 250 including a portable base unit 202 having a visual display 204. In various embodiments, visual display 204 includes a viewable area 206 including a plurality of indicative segments and a central viewable area 208. As illustrated in FIG. 2B, central viewable area 208 includes a visual indication of a base station 212, a first remote unit 214, and a second remote unit 252. The graphical symbols used as the visual indications of the base station 212 (the square), the first remote unit 214 (the star) and the second remote unit (the triangle) are not limited to theses or any other particular graphic symbols, and may include any graphic symbols, text, or combination of graphic symbols and text, including numbers, to visually display and differentiate between the base station and any remote units that are depicted in a given visual representation being provided by base unit 250.

As illustratively shown in FIG. 2B, a relative position between base unit 212 and the first remote unit 214 is depicted by line 216, which extends to indicative segment 256, and a relative position between base unit 212 and the second remote unit 252 is depicted by line 254, which extends to indicative segment 260. In various embodiments, it is not necessary that either one of lines 216 or 254 are visually displayed the visual display 204. In various embodiments, lines 216 and 254 are merely illustrative of the relative position between the base unit 212 and remote units 214 and 252 respectively.

In various embodiments, indicative segment 256 is activated to visually indicate the relative position of base station 212 and the first remote unit 214, and indicative segment 260 is activated to visually indicate the relative position of base station 212 and the second remote unit 252. The visual indication utilized by indicative segments 256 and 260 are not limited to any particular type of visual indication, and includes any of the types of visual indication for indicative segments described herein. In various embodiments, either one or both of indicative segments 256 and 260 utilize strobed lines 259 and 261 respectively to visually depict the relative position of the first remote unit 214 and the second remote unit 252 respectively. In various embodiments, the visual indication utilized by indicative segments 256 and 260 is the same type of visual indication. In various embodiments, the types of visual indication used by indicative segments 256 and 260 is different. By way of illustration, in some embodiments indicative segments 256 uses a first color to indicated that it is activated, and indicative segment 260 uses a second and different color to indicate that it is activated. In various embodiments, the different colors are incorporated with the strobed line segments, wherein the strobed line segments are displayed for both the indicative segments 256 and 260 but wherein the color of the indicative segments 256 and 260 are different.

In various embodiments, the color of the indicative segments used to indicate a relative portion of a particular remote unit matches the color used to display the symbol of the remote unit on the visual display 204. By way of illustration, if a green symbol is used to visually depict remote unit 214 on the visual display 204, indicative segment 256 will be activated to appear green when the relative position of base unit 212 and remote 214 align with indicative segment 256 on the visual display 204. A different color can be used to visually display the second remote unit and the indicative segment 260.

It would be understood that any number of different remote units could be displayed using any combination of symbols, numbers, text, and colors in order to visually discriminate the different relative positions of the base units and the any number of different remote units being tracked by a system within which the portable base unit is operating.

In various embodiments, base unit 250 includes a one or more displays of additional information 218 and 258. The information included in additional information 218 and 258 is not limited to any particular type of information, and includes but is not limited to any of the information described herein with regards to additional information 218 and FIG. 2A.

Referring again to FIG. 2B, in various embodiments additional information 218 includes information related to the first remote unit 214, including relative or absolute positional information associated with remote unit 214. In various embodiments, additional information 258 includes information related to the second remote unit 252, including relative or absolute position information associated with remote unit 252.

In various embodiments, only one tracked subject, such as 214 or 252, are shown on the viewable area 206 at any one time. Base unit 200 is operable to allow a user to select with subject being tracked is to be displayed at any given time. Selection of the subject being tracked that is to be displayed in various embodiments is made using a pushbutton.

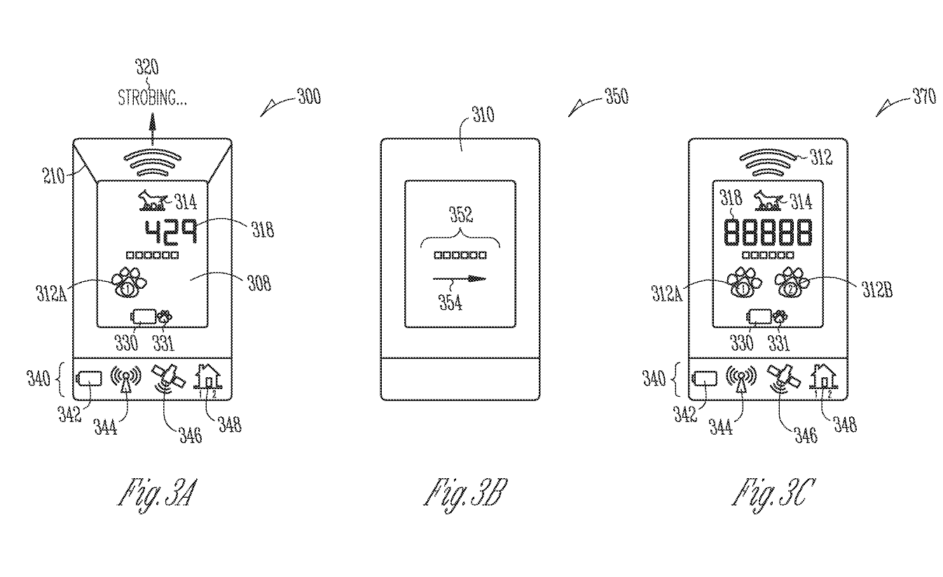

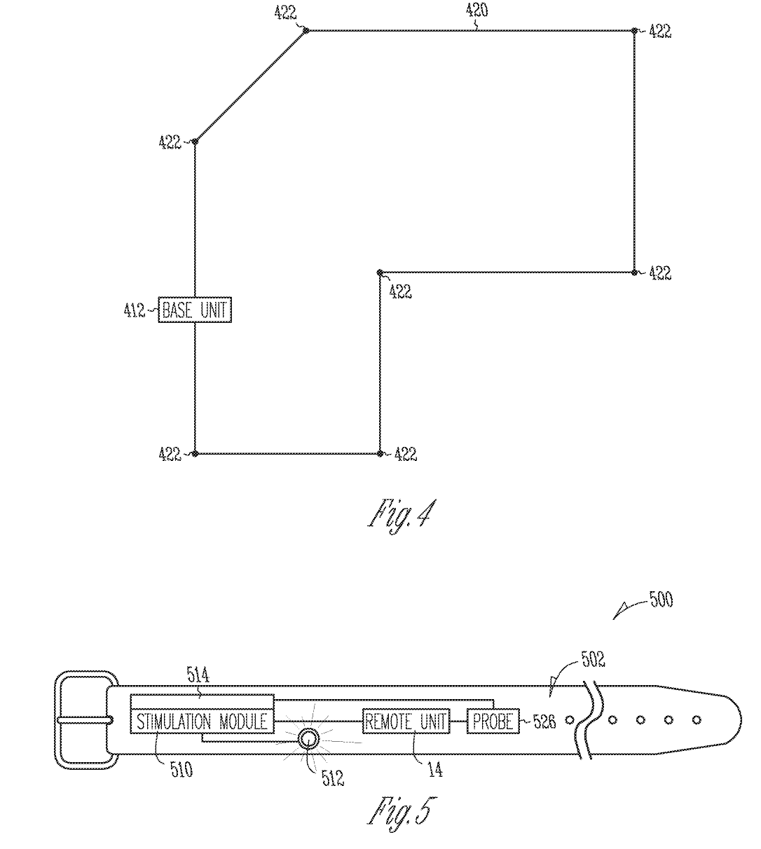

FIG. 3A illustrates a visual display 300 provided by a visual display of a base unit. In various embodiments, visual display 300 is an illustrative display that is provided on a visually display 204 of a portable base unit 200 as shown in FIG. 2A, or is display 16 of base unit 12 as shown in FIG. 1.

In FIG. 3A, the visual display 300 includes a viewable area 302 including a graphical representation of a base unit 312 and a graphical representation of a remote unit 314. Although the base unit 312 is shown as paw-print including a number “1” within the paw-print, the graphical representation of the base unit 312 is not limited to such symbols. Further, although the remote unit 314 is depicted as a silhouette of a dog, the graphical depiction of the remote unit 314 is not limited to such a symbol.

FIG. 3A includes additional information 318, which includes a quantity of “429.” In various embodiments, the quantity 429 indicates a distance, in some pre-determined units of distance, between base unit 312 and remote unit 314.

In various embodiments, viewable display 302 includes a plurality of indicative segments 310 that surround the central viewing area 308. A particular indicative segment 320 of the plurality of indicated segments 310 is activated to indicate the relative positional relationship between base unit 312 and remote unit 314.

In various embodiments, visual display 300 includes a visual indication 330 of a status indication for a battery powering the remote unit 314. The visual indication 330 is not limited to any particular type of indicative symbol, and in various embodiments includes a numerical indication of the level of charge present on a battery located in remote unit 314. In various embodiments, battery identification symbol 331 is displayed near some portion of visual indication 330 to associate the visual indication of the battery state with the particular remote unit where the battery is located. In various embodiments, battery identification symbol 331 includes a number, for illustrative purposes a “1,” that associates the visual indication 330 with the remote unit 314.

In various embodiments, graphical depiction of the remote unit 314 is only displayed when the subject being tracked is stationary, such as when a dog being tracked lays down, or in various embodiments including pointing dogs, is stationary and pointing, commonly referred to as being “on point.”

In various embodiments, visual display 300 includes one or more additional indicative display areas 340. In various embodiments, the additional indicative display areas 340 are a portion of the viewable area 302, and the control of the addition indicative display areas 340 is preformed by the same device and means as used to provide the other portions of viewable area 302. The additional inductive display areas 340 are not limited to any particular types of symbols, graphics, text, or colors, or to any particular combinations of symbols, graphics, text, or colors, and include any symbols, graphics, text and colors that can be generated and displayed on viewable area 302 and used to display information.

In various embodiments, addition indicative display 340 include a battery status indicator 342 operable to display a status associated with the battery included in a base unit that includes the visual display 300.

In various embodiments, additional indicative display areas 340 includes a signal strength indication 344 operable to display information related to whether a connection is established between the base unit 312 and remote unit 314. In various embodiments, signal strength indication 344 includes a number or some other indication of the strength of any signal being received from remote unit 314 by base unit 312.

In various embodiments, additional indicative display areas 340 includes a satellite signal indication 346. In various embodiments, satellite signal indication 346 is operable to display information related to whether a satellite signal connection is established by a remote unit being tracked, by the base unit 312, or both.

In various embodiments, additional indicative display areas 340 includes a home base position indication 348. In various embodiments, a home base position indication 348 is operable to display information related to one or more designated home base positions. In various embodiments, the visual display is operable to display information, including directional and distance information related to a relative or absolute position of the one or more designated home base positions. By way of illustration, when a user leaves their vehicle to walk their dog, the location of the vehicle can be designated as a home base position. The display is then operable to indicate through visual display the location of the base unit with respect to the designated home base position.

FIG. 3B illustrates another visual display 350 provided by a visual display unit of a base unit. The visual display unit providing display 350 can be any base unit described herein. In various embodiments, visual display 350 is referred to as a “splash” display, and in various embodiments, is displayed during times when the base unit is preparing to provide a different visual display, such a when the base unit is first turned on, or when the base unit is changing from one mode to another mode. In various embodiments, visual display 350 includes an animated plurality of graphic symbols 352, such as but not limited to an series of squares, that are sequentially displayed in order to provide a visual perception of motion in a direction indicated by arrow 354. arrow 354 is not necessarily visible as part of visual display 350, and i merely included in FIG. 3B to represent the direction of the perceived motion provided by the animation of graphic symbol 352.

The type of animation used to animate graphic symbol 352 is not limited to any particular type or types of animation, and is chosen to be a type of animation that would indicate to a user that the base unit is operating, but is in some type of preparation or other in-between state.

FIG. 3C illustrates still another visual display 370 provided by a visual display of a base unit. In various embodiments, visual display 370 is an “all segments” display, wherein all the available segments programmed for display are provided at once, or in some pre-determined sequence. In various embodiments, all of the plurality of indicative segments 310 are activated at a same time. In various embodiments, the plurality of indicative segments 310 are activated in some pre-determined sequence, such as but not limited to one at a time in a consecutive order around the viewable areas 308. In various embodiments, visual display 370 includes a first remote unit indication 312A and a second remote unit indication 312B. In various embodiments, the number of remote units indications included in visual display 370 include the number of remote units that the base unit providing the visual display 370 is configured to track, as described herein.

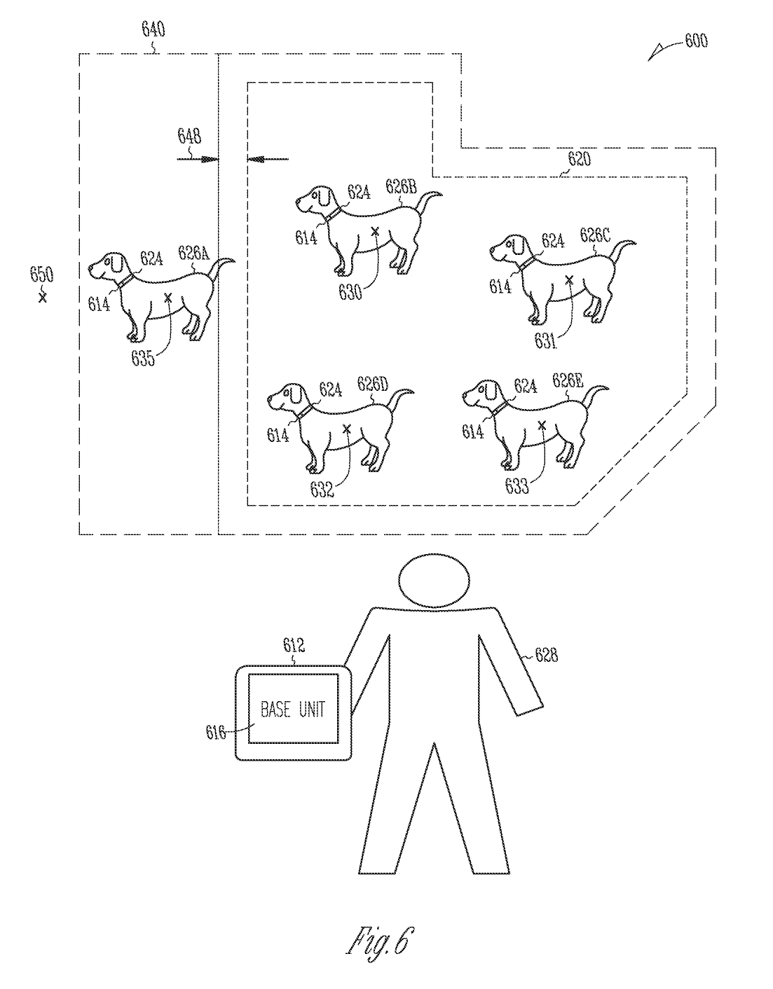

FIG. 4 illustrates a base unit 412 used in a fence definition mode. According to various embodiments, a perimeter 420 may be defined by moving the base unit 412 along a desired path. In various embodiments, the base unit 412 is put into a mode to retrieve its GPS location data along a path and to store that data as the boundary for a perimeter 420. In this manner, the perimeter 420 is stored as a series of points or coordinates defining a path. By defining the perimeter 420 as a series of coordinates, the perimeter can take any shape, geometric or otherwise. Alternatively, according to another embodiment, the base unit 412 may be moved along a perimeter 420 and specific corner points or “fence posts” 422 may be input, and the perimeter 420 data may be stored with respect to the fence posts 422. In this manner, the perimeter may be stored as a number of points and vectors between the points. The perimeter may also be described as a circular area by defining a center point and a particular radial length. Other methods of defining a perimeter are also contemplated as embodiments of the inventive subject matter. These methods include using two or more base units to create boundary points or lines based on the location of the base units.

The perimeter itself may be created in a number of ways. According to one embodiment of the inventive subject matter, a boundary creation tool may be used to create a customized perimeter. The boundary creation tool may reside on the base unit or alternatively on a personal computer or an internet website or other convenient places for a user to access. The tool may allow a user to create a perimeter as described above by recording GPS coordinates. Alternatively, perimeter information may be created by simple drawing of lines and points. In yet another embodiment of the inventive subject matter, perimeter information may be downloaded from the a computer network, or created using mapping software. A number of embodiments are contemplated for the creation of the perimeter information. Additionally, the perimeter need not be fixed. Once defined, the perimeter may be moveable at a predetermined rate, or with reference to a base unit or a remote unit, or some other mobile reference point.

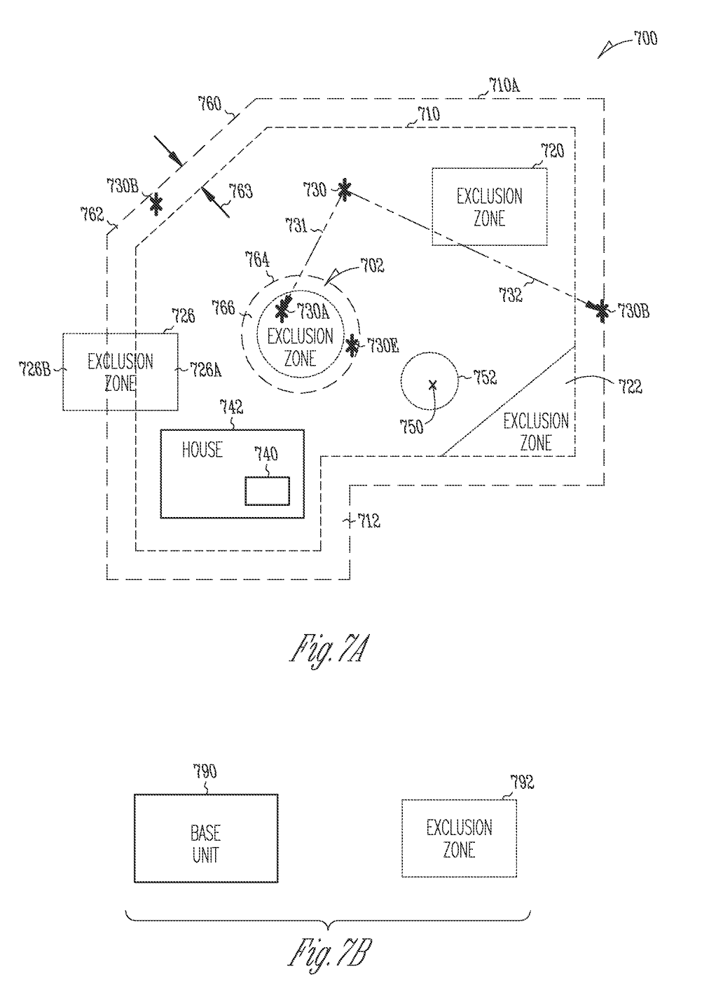

FIG. 5 illustrates a particular implementation of the positional monitoring system including a pet collar 500. In various embodiments, pet collar 500 involves a remote unit 514 being incorporated into pet collar 500, wherein remote unit 514 can be, but is not limited to, any of the remote units 14 as shown in FIG. 1. In various embodiments, pet collar 500 includes the collar strap 502, and a remote unit 514 coupled to the collar strap 501. In various embodiments, the remote unit 514 is adapted to automatically periodically or continuously transmit its GPS-identified location to a base unit, such as but not limited to base unit 412 as illustrated in FIG. 4, so that the pet owner may monitor the location of the pet wearing collar 500.

A variety of operational options may be further included in such a system to enhance the overall effectiveness of the location monitoring apparatus.

In various embodiments, collar 500 includes a stimulation module 510. In various embodiments, stimulation module 510 is operable to receive signals from a base unit (not shown in FIG. 5), the signals requesting that that stimulation be provided at the collar 500. In various embodiments, stimulation module 510 includes one or more devices operable to produce and provide one or more forms of stimulation. In various embodiments, stimulation device 512 includes a device operable to provide an audio sound as a stimulation. In various embodiments, stimulation device 512 includes a device operable to provide vibration as a stimulation.

In various embodiments, stimulation module 510 includes an audio device, such as a buzzer or a speaker, operable to provide audio sound as a form of stimulation. In various embodiments, stimulation module 510 is coupled to probes 526, wherein stimulation module 510 is operable to provide electric power to the probes 526 as a form of electrical stimulation. In various embodiments, stimulation module 510 includes a scent generator 514 operable to generate and release an odor in the area of collar 500 as a form of stimulation.

In various embodiments, stimulation module 510 is operable to provide different forms of stimulation at a same time. In various embodiments, stimulation module 510 is operable to provide a first form of stimulation during a first time, and then a second and different form of stimulation at a second and subsequent time. In various embodiments, stimulation module 510 provides one or more types of stimulation in response to one or more signal received at the stimulation module 510 that have as a source of the signals a device remotely located from the collar 500, such any embodiments of a base unit or a base station as described herein.

In alternative embodiments, the strap represented by pet collar 500 is a belt or a wrist band that can be worn by a child that is a subject to be tracked. Such belt or wrist band would not include the probes 526 and would not be capable of providing electrical stimulation. However, the belt or wrist band in various embodiments' includes device 512 operable to provide audio or vibratory stimulation.

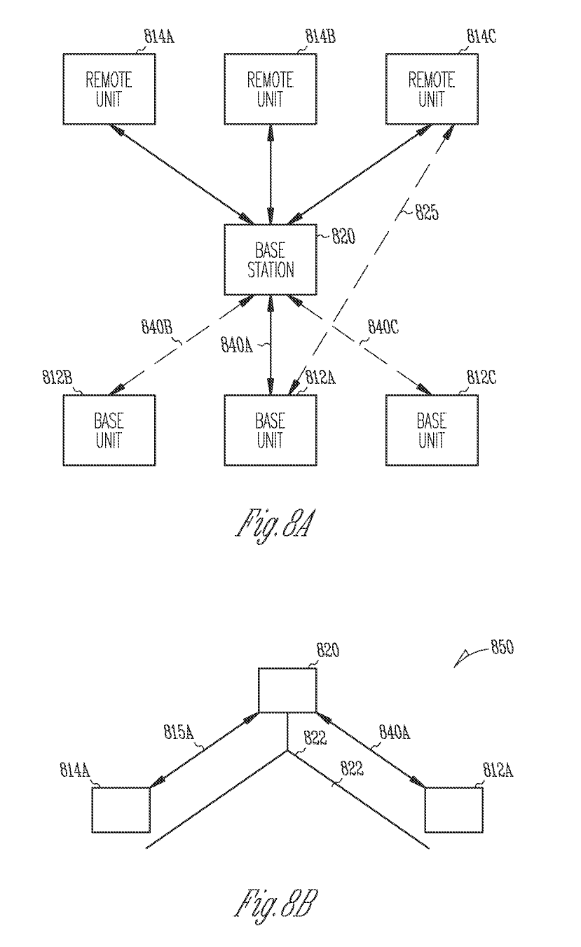

FIG. 6 illustrates a pet location monitoring system 600 according to various embodiments. By way of illustration, a perimeter 620 as described above with respect to FIG. 4 is programmed into a base unit 612 to define a “safe-zone” within which the pet 626 may be allowed to freely roam. A collar 624, such as the pet collar 500 illustrated in FIG. 5 including a remote unit 614, is attached to the pet 626. In various embodiments, remote unit 614 any combination of the features described for remote unit 514, as described in conjunction with FIG. 5.

Referring again to FIG. 6, while pet 626 remains within the perimeter 620, pet 626 is determined to be within the “safe-zone.” In various embodiments, a relative position of base unit 612 and pet 626 is displayed on visual display 616 of base unit 612, and may be viewed by a user 628. In various embodiments, all or some portion of perimeter 620 is displayed on visual display 616, including showing the relative position of pet 626 to perimeter 620. Various positions 630, 631, 632, and 633 for pet 626 are shown in FIG. 6 as illustrative positions for pet 626 that are within perimeter 620. Since each of these positions is within the defined “safe-zone,” no alarm conditions would be activated by the base unit 612.

Once the remote unit 614 on the pet collar 624 attached to the pet 626 goes beyond the predefined boundary of perimeter 620, as illustrated by pet 626A at position 635, the pet 626 is determined to be outside the perimeter 620, and is therefore outside the “safe-zone.” In various embodiments, an alarm is activated at the base unit 612 to alert the user 628 to the undesired location of the pet 626. In various embodiments, the alarm is an audio alarm, a visual alarm, or both an audio alarm and a visual alarm.

In other embodiments of the inventive subject matter, base unit 612 is configured to emit an instructional signal to remote unit 614 to activate an stimulation provided at collar 624 when pet 626 is outside the perimeter 620. In various embodiments, collar 624 and remote unit 614 include a stimulation module, such as stimulation module 510 as shown in FIG. 5.

Stimulation is not limited to any particular type of stimulation, and includes but is not limited to any type of stimulation that is perceivable by one or more senses of the subject being tracked. Stimulation includes electrical stimulation provided by probes, such as probes 526 as shown in FIG. 5, operable to provide an electrical stimulation to a pet 626 wearing the collar 624. In various embodiments, stimulations includes releasing a substance at or near the collar 624 that can be sensed as a smell by the pet 626 wearing the collar 626. In various embodiments, the released scent is a odor determined to be unpleasant to the pet 626, and thus when released as a stimulation, discourages the pet 626 from crossing the perimeter 620 to any position outside the “safe-zone.”

In various embodiments, the stimulation provided is an audible tone that is detectable by the sense of hearing of pet 626. In various embodiments, the audible tone indicates that the pet 620 is outside perimeter 620.

In some embodiments, pet 626 does not return to within the perimeter 620 within the pre-determined time, additional stimulation, such as electrical shock stimulation, will be provided at the collar 624. In some such embodiments, pet 626 first receives an audio stimulation when first leaving the safe-zone as encouragement to return to the safe-zone within a given time in order to avoid the electrical stimulation. If pet 626 does not return to the safe-zone within the given time, electrical stimulation is applied to pet 626. In various embodiments, the signals the prompt stimulation module of collar 624 to provide the stimulation are provided by base unit 612 as a transmitted signal received at remote unit 614, or directly by stimulation module included in remote unit 614.

In various embodiments, when it is determined that pet 626 has left the safe-zone and is outside the perimeter 620, base unit 612 provides an audio alarm signal. In various embodiments, display 616 of base unit 612 provides positional information regarding the location of pet 626, even when pet 626 is outside the perimeter 620. using the base unit 612, a user 628 is able to determine, by using visual display 616, the location of pet 626 even after the pet 26 has left the safe-zone.

In various embodiments, electrical pulse to an exterior surface or probe 526 extending from remote unit 614 and in contact with the pet 626, so as to “shock” the pet 626 when, for example, the pet has traveled beyond the predefined boundary. Other options and capabilities are contemplated as being useful according to various embodiments of the inventive subject matter, which options and capabilities may be directed through wireless radio frequency communication between the respective units of the system 600.

In various embodiment of positional monitoring system 600, perimeter 620 is set up around a number of dogs. By way of illustration, instead of pet 626 as shown at positional locations 630, 631, 632, and 633 being a single dog, each of these positions represents a different dog 626B-E at each of positional locations 630, 631, 632, and 633 respectively. Each dog 626B-E is wearing a pet collar 624 equipped with a remote unit 614. From another location, the user 28 can monitor the dogs 626B-E as individual remote units using the base unit 612. In various embodiments, each of the dogs 626B-E are tracked by displaying on display 616 the positional relationship of each dog relative to base unit 612.

According to some embodiments of the inventive subject matter, displaying the location of each dog 626B-E on the display 616 may be confusing, or may be too much information to show if the display 616 is relatively small. The base unit 612 may optionally display the location of a remote unit 614 coupled to a given one or more of dogs 626B-E only if the remote unit 614 is outside of the perimeter (see dog 626A). In this case, because remote unit 614A is outside of the perimeter 620, the base unit 612 alerts the user 628 and the display 616 shows the location of dog 626A wearing remote unit 614A with respect to the base unit 612. According to this embodiment, tracking and location information only needs to be displayed to the user 628 when a remote unit 614 has crossed the perimeter 620. This embodiment may also be applicable to teachers or parents trying to keep track of children, or a number of other similar situations.

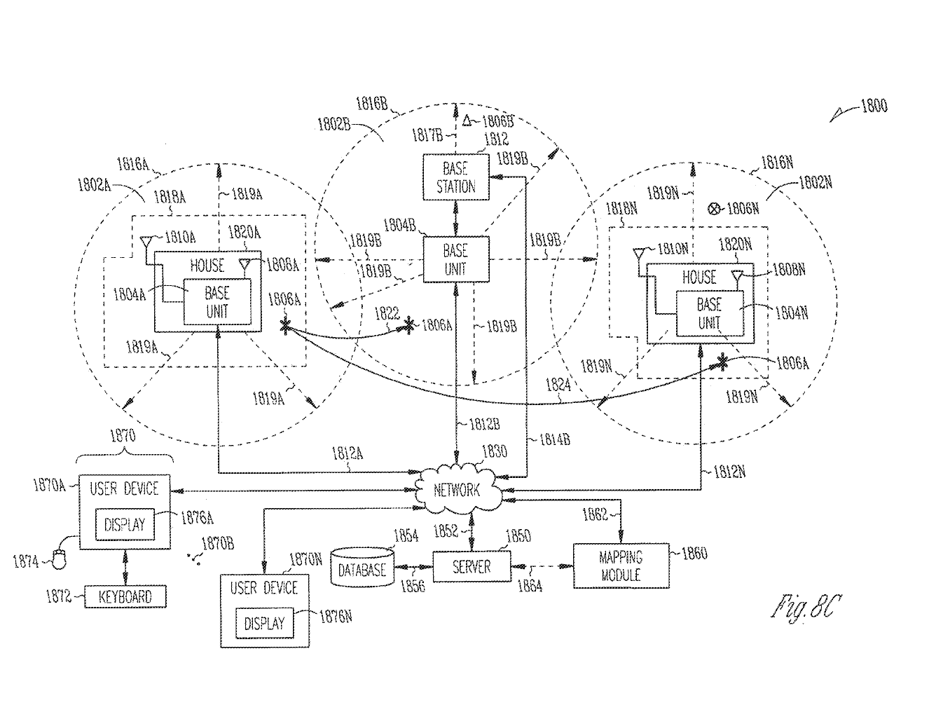

FIG. 7A illustrates an illustrative set of zone configurations 700 according to various embodiments. Zone configurations 700 include a safe-zone 702 defined and bounded by a perimeter 710. Perimeter 710 can be established by any method or technique, such as but not limited to using the fence definition mode as described herein. As shown in FIG. 7, safe zone 702 includes one or more exclusion zones 720, 722, 724, and 726. Exclusion zones are zones that may be partially or completely within a “safe-zone” but are also determined to be off limits to subjects that might be moving within the safe-zone and are being tracked by a remote unit within the positional monitoring system.

By way of illustration, perimeter 710 defines a “safe-zone” within which it is desirable to have a child or a pet remain within. In addition, exclusion zone 724, by way of illustration, represents a swimming pool that, in the case of a child, may represent a hazard, and thus is excluded from the “safe-zone” space within perimeter 710.

In various embodiments, whenever a subject being tracked, (i.e. a child or a pet illustratively represented by remote unit 730), remains within the safe-zone defined by perimeter 710 and remains outside any defined exclusion zones, such as exclusion zones 720, 277, 724, and 726, no alarm conditions are activated on a base unit (illustratively shown as base unit 740 in illustrative house 742). being used to monitor and tack the remote units associated with the subject being tracked.

If the subject being tracked enters any one of the exclusions zones, as illustratively depicted by arrow 731 and remote unit 730, wherein remote unite 730 is tracked as being within exclusion zone 724 an alarm condition will be activated at base unit 740. In various embodiments, the location of remote unit 730A is displayed on a display included in base unit 740. In this way, a user of the positional monitoring system can be alerted to the fact that the subject being traced has entered into an exclusion zone.

In various embodiments, an alarm is also activated if the subject being tracked exits the safe-zone defined by perimeter 710, and indicated by arrow 732 and the position of remote unit 730B.

In various embodiments, the type of indication activated when a subject being tracked enters an exclusion zone is the same as when the subject being tracked exits the safe-zone as defined by the perimeter 710. In various embodiments, the type of indication includes an audio alarm. In various embodiments, the type of indication includes a alarm display provided on the display included in base unit 740. In various embodiments, the type of indication provided includes both an audio and a visual alarm.

In various embodiments, the type of indication provided when a subject being tracked enters an exclusion zone is different from the type of indication provided when the same subject big tracked exits the safe-zone as defined by perimeter 710.

In various embodiments, different subjects being tracked have different safe zones and different exclusion zones associated with each individual subject being tracked. By way of illustration, a child (subject 1) and a dog (subject 2) may both be coupled to separate remote units, wherein each of the separate remote units are being tracked from a common base unit, such as base unit 740 in FIG. 7. In various embodiments, the perimeter 710 is the same for both the child and the dog, as this represents a boundary of a property where the child and the dog live. Exclusion zone 724 is a swimming pool, with is determined to be an excluded zone for both the child and the dog (assuming the child is allowed not use the pool unless and only when there is adult supervision present). Exclusion zone 720 surrounds a garden area, the child being allowed to go into the garden area, but the dog is not supposed to enter this same garden area. In various embodiments, different exclusion zones, including the pool of exclusion zone 724 but not including the garden of exclusion zone 720 are configured for the remote unit used to track the child, and exclusion zones including the pool and the garden exclusion zones 724 and 7200 are configured for the remote unit used to track the dog. The activation of the alarms at base unit 740 would be capable of providing alarms specific to each remote units and based on the configuration designated for each of the particular remote units.

Continuing with the above illustration, an alarm would be activated with either the dog or the child, or both the dog and the child, are within the pool exclusion zone 724, and an alarm would only be activated if the dog entered the exclusion zone 720, regardless of whether the child was within the garden exclusion zone 720. No alarm condition would be activated if the child entered the garden exclusion zone 720.

In various embodiments, exclusion zones can be selectively activated and deactivated without losing the locational information associated with the exclusion zone. By way of example, the exclusion zone 724 associated with the swimming pool can be selectively activated when conditions are appropriate for the child to be in and around the swimming pool, such as when an adult is present to watch over the swimming pool area. When deactivated, the child can enter the exclusion zone 724 to swim and use the pool area without activating an alarm at the base unit. Once the child has finished using the swimming pool, the exclusion zone 724 can be activated again with respect to the remote unit being used to track the child, and the child would be allowed to play in the yard, but if the child would enter the exclusion zone 724, an alarm condition would be activated at base unit 740.

In addition, different types of stimulation can be provided to different subjects being tracked based on the same set of configured zones. By way of illustration, electrical stimulation can be provided to a dog if the dog leaves the “safe-zone” as defined by perimeter 710, and electrical stimulation can be provided to the dog if the dog enters any of the exclusion zones 720, 722, 724, 726. Such electrical stimulation would never be appropriate for use in connection with a remote unit coupled to and used to track a child. A remote unit coupled to a child is never to have the physical means, such as the electrical probes 526 as shown in FIG. 5 operable to deliver electrical stimulation.

However, a remote unit coupled to a child and used to track the child could have an audio alarm included as part of the remote unit. In various embodiments, the audio alarm could be activated to provide the child with a audio indication that they are proceeding to move either outside of the safe-zone or into an excluded area.

Configurations of exclusion zones are not limited to any particular size or shape. Illustrative same zone 720 is rectangular, illustrative exclusion zone 722 is triangular in shape, and exclusion zone 724 is circular in shape. In various embodiments, any size or shape zones are that the positional monitor system is capable of defining can be used.

The extent of an exclusion zone is not necessarily limited to being totally or partially within any given perimeter. By way of illustration, exclusion zone 726 is has a portion 726A that is within the safe-zone defied by perimeter 710, and a portion that is outside the safe-zone defined by perimeter 710. In such instances, in various embodiments, the activation or non-activation of alarms associated with a particular remote unit, such as remote unit 730, is configured individually and separately for the safe-zone 710 and the exclusion zone 726, and is not necessarily impacted by a change to the location, or the activation or deactivation of one zone configuration versus another. By way of illustration, the location of perimeter 710 can be modified without affecting the location and the configuration associated with any of exclusion zones 720, 722, 724, 726.

In various embodiments, any one of the perimeter 710 or the exclusion zones 720, 722, 224, 726 can be configured to be dynamical movable. By way of illustration, an exclusion zone 752 can be configured to be an area around a remote unit 750. As remote unit 750 moves, the area include in exclusion zone 752 moves so as to maintain a certain relationship, such as an area defied by a given radius, around remote unit 750. In various embodiments, exclusion zone 750 is configured to be an exclusion zone of another remote unit, such as the remote unit coupled to the dog, wherein if the dog comes within the exclusion zone defined by exclusion unit 752, an alarm is activated at base unit 740.

In various embodiments, one or more of the configurable zones is associated by a buffer zone and a second perimeter. By way of illustration, perimeter 710 can be associated with a buffer zone 762 and a second perimeter 762. In various embodiments, the location of second perimeter 763 is determined by a given distance 763 perpendicular to perimeter 710 at every point along perimeter 710. Other techniques can be used to determine the location of the second perimeter 760, including any techniques or methods described for establishing a first perimeter using a fence determination mode as described herein.

In various embodiments, the area in the space between the perimeter 710 and the second perimeter 760 is a safe-zone buffer area 762. In various embodiments, different types of alarms are activated depending on if the subject being tracked is outside perimeter 710 but within the safe-zone buffer areas 762, as represented by the location of remote unit 730B, and when the subject being tracked is outside the second perimeter 760, as represented by the location of remote unit 730C.

In various embodiments, a first stimulation is provided to a subject being tracked when the subject enters the safe-area buffer zone 762, and a second stimulation is provided to the subject when the enter an area outsize the second perimeter 760. By way of illustration, a dog being tracked by a remote unit is provided an audio stimulation when the dog enters the safe-zone buffer area 762. When the dog is provided the audio stimulation, the dog has been conditioned to understand that they are outside the safe-zone, and should not proceed farther. If the dog continues to move until they are outside the second perimeter 760, a second stimulation, such as electrical shock, will be provided at the remote unit collar to the dog. In this way, a dog will be provided a warning, such as the audible alarm, before being provided with an electrical stimulation, and this may discourage the dog from exiting the area of the second perimeter 760, and encourage the dog by the auto alarm to return to the safe-zone defined by perimeter 710.

In various embodiments, one or more of the exclusion zones includes a buffer area and a second perimeter. By way of illustration, exclusion zone 724 is surrounded by a second perimeter 764, wherein the area between the outside perimeter of exclusion zone 724 and 764 includes a buffer area 766. In various embodiments, when a subject being tracked, as represented by remote unit 730E, is within buffer area 766, a first alarm is activated at base unit 740. If the subject being tracked proceeds into the exclusion zone 724, a second alarm is activated base unit 740. By way of illustration, second perimeter 764 represents a boundary line around a swimming pool area, the buffer zone 766 represents the area of the pool deck, and the area within exclusion zone 724 is the actual area of water within the swimming pool area. A first type of alarm, such as an audio beeping, can be activated if a subject being tracked, such as a child, enters the buffer areas 766. The alarm is intended to alert some that the child may be too near to the pool. If the subject being tracked enters the exclusion area 724, a second alarm, using a constant audio tone that is much louder than the first of beeping alarm, is activated to alert someone that the child may have fallen into the swimming pool.

In various embodiments, elevational information is provided as part of tracking, or as part of an alarm. By way of illustration, an indication of the elevation of the subject being tacked is provided as part of normal tracking, or as part of information provided when an alarm is activated, or both. In various embodiments, the elevational information can indicate that the subject being tracked, for example a child, has fallen into a pool or a pond, and is below the water level, or has fallen into a hole or a well. Elevational information can be useful in quickly location the subject being tracked, and as an indication of some unusually dangerous situation the subject being tracked has encountered.

FIG. 7B illustrates an illustrative exclusion zone 792 and base unit 790 according to various embodiments. As shown in FIG. 7B, no perimeters that are intended to contain a subject to be tracked are necessary. In various embodiments, only an exclusion zone, wherein the subject being tracked is not allowed to enter into, is included in the areas defined for the subject being tracked.

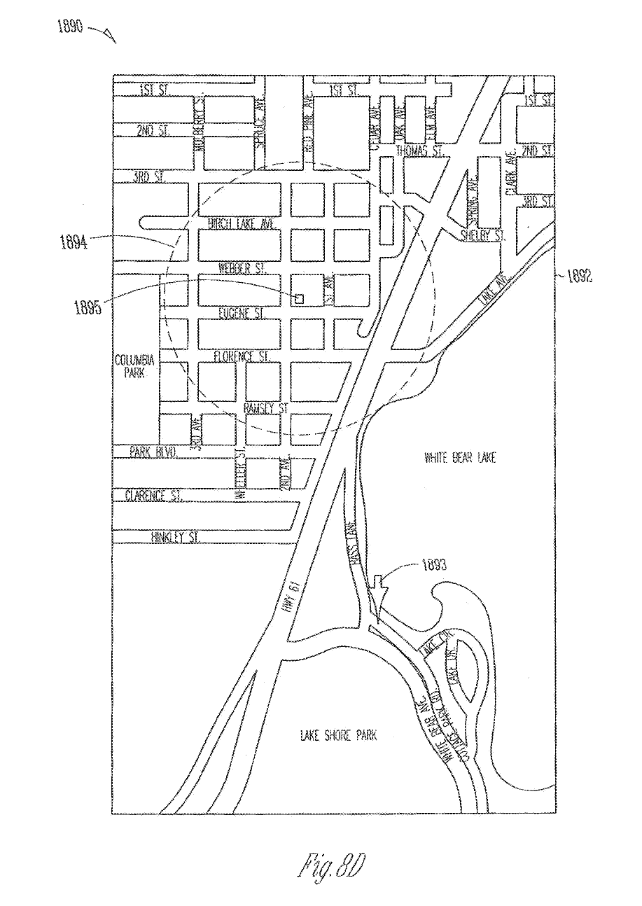

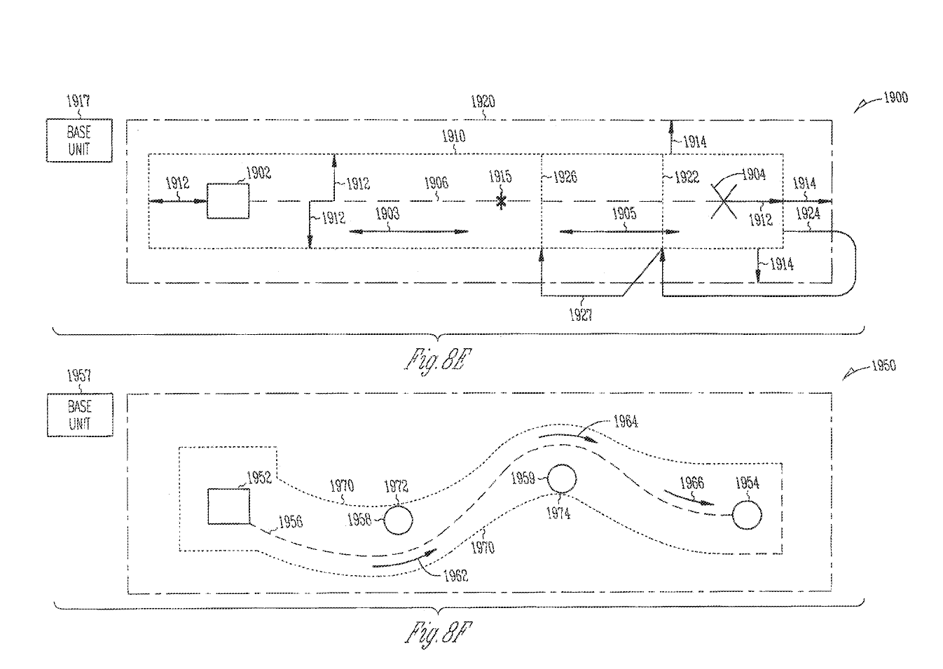

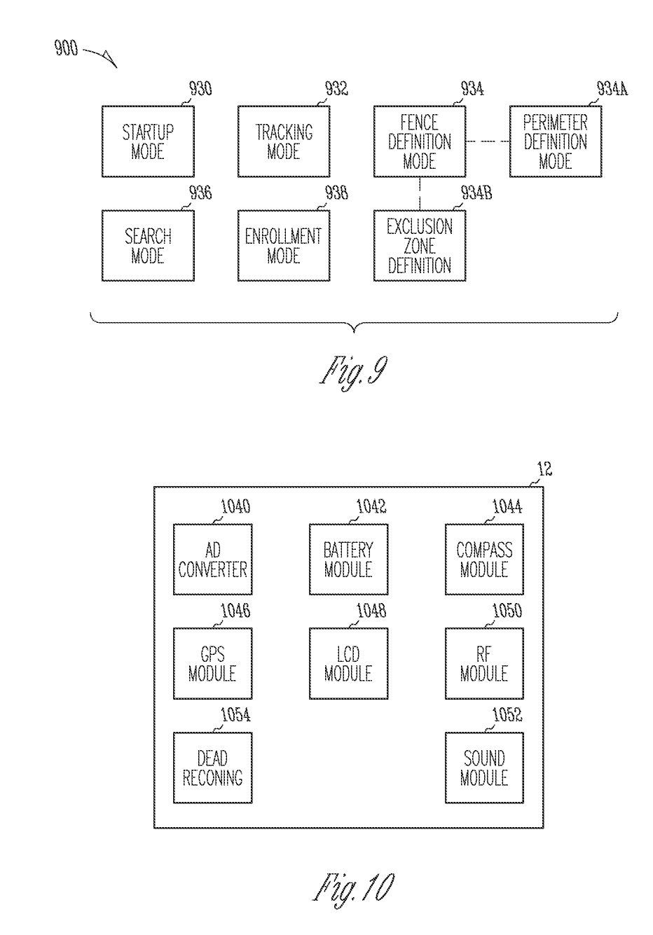

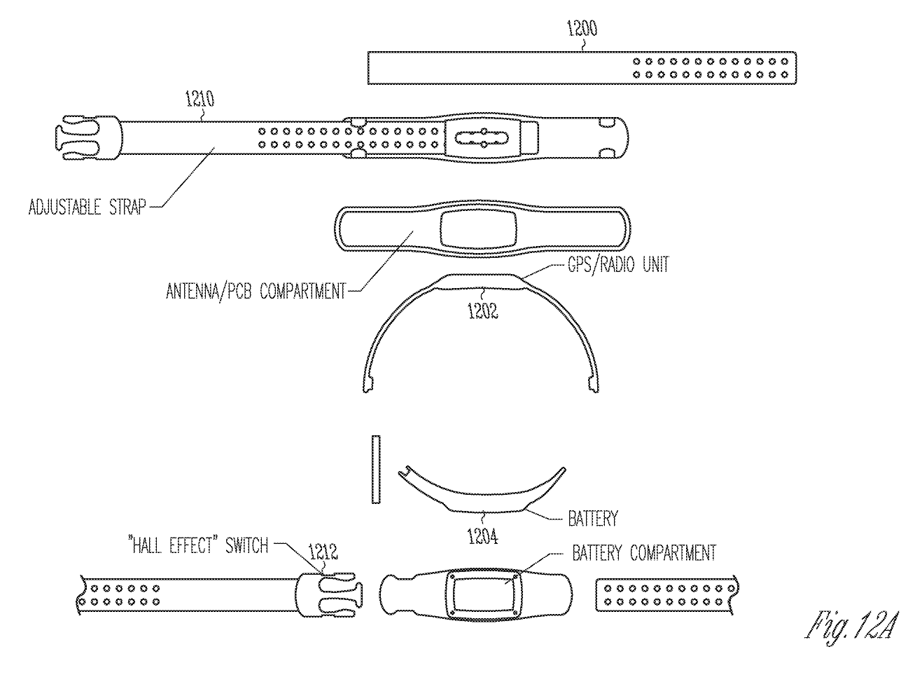

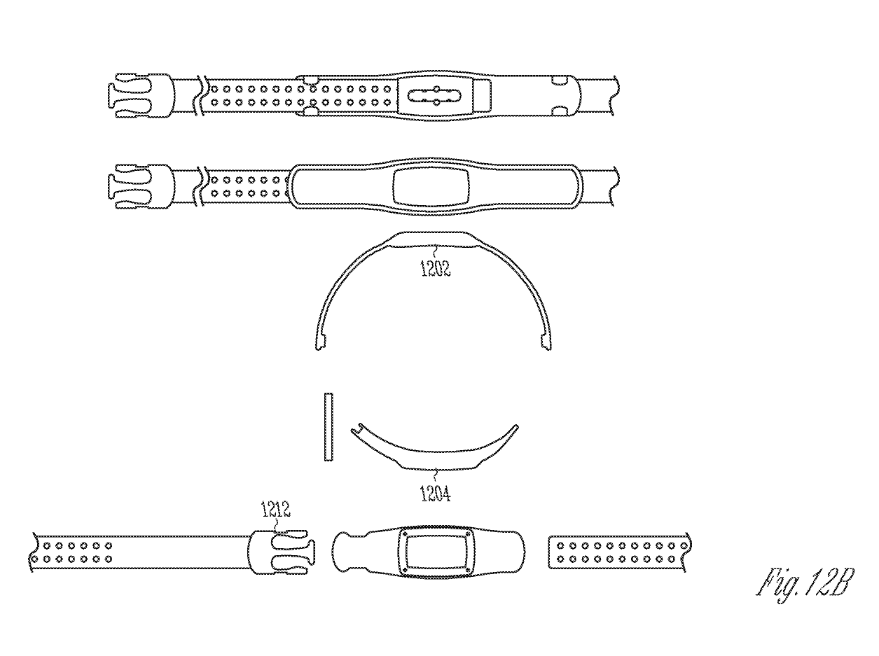

FIG. 8A illustrates a positional monitoring system 800. Positional monitoring system 800 includes a base station 820 that is operable to be wireless communicatively coupled to remote units, such as remote units 814A-C. Remote units 814A-C are not limited to any particular type or types of remotes units, and can include any type of or combination of typos of remote units described herein. In various embodiments, base station 820 is operable to communicatively like with one or a plurality of remote units 814A-C using one or more types of wireless connections 815-A-C respectively. Wireless connections 815A-C are not limed to any particular type or types of wireless connection, and include any types or types of wireless connections operable to provide wireless commutations between the remote units 815A-C and base station 820.

In various embodiments, base station is operable to perform error correction, re-amplification of received signals, and to function as a computer router.

In various embodiments, base station 820 is operable to be communicatively couple to one or more base units 812A-C. In various embodiments, a base unit such as base unit 812A is coupled to base station 820 using a connection 840A. connection 840 is not limited to any particular type of connection, and in some embodiment, is a wireless connection. In various embodiments, connection 840 includes physical conductors, such as but not limited to wires, busses, and transmission lines, operable to allow communications between base station 820 and base unit 812A. In various embodiments connection 840A is a same type connection as wireless connections 815A-C.

In various embodiments, base station 820 is operable to provide data processing of data received from remote units 814A-C, including but not limited to processing of positional data provided by any of remote units 814A-C. In various embodiments, base station 820 is operable to provide processed data, including but not limited to positional data associated with remote units 814A-C, to one or more of base units 812A-C. In various embodiments, base station 820 provides information about selected ones of remote units 814A-C to a given one, or some combination of, the base units 812A. By way of illustration, base station 820 is configurable to provide locational information provided by remote unit 814A to base unit 812A, to provide locational information provide by remote unit 814B to base unit 814B, and to provide locational informational information provided by remote unit 814C to base unit 812C. In various embodiments, base station 820 is operable to provide any one of base units 812A-C with locational information provided by any one, or any plurality of, the remote units 814A-C. Thus, in various embodiments, base station 820 functions as router.

In various embodiments, base station 820 is operable to provide signal processing of signals sent from the any of the base units 813A-C to a given one, or some given combination of, remote units 814A-C. By way of illustration, when base unit 812A provides a signal intended to cause remote unit 814A to provide a stimulation, the signal from the base unit 812A is received and processed by base station 820. Base station 820 then produces a signal in a format and of a type that should be received and properly interpreted as a signal to provide the estimation by remote unit 814A.

In various embodiments, base station 820 is operable to process signals provided by a base unit that would not be received or properly interpreted by a remote unit, and to process these received signals into a format or into a type of signal that can be properly received and properly interpreted by the remote unit for which the signal was intended. In various embodiments, signals provided by remote units 814A-C and that would not be received or properly interpreted by a base unit are processed by base station 820 and transmitted these processed signals to the base units in a format and using a signal type that should be properly received and interpreted at the base units. In various embodiments, one or more of the remote units 814 are operable to provide signals that are in different format from one another, and the base station 820 is operable to transform these various signal formats into a same format. This common format can then be transmitted to one or more of base units 813. In a similar fashion, signals provided by one or more of the base units 816A-C are provide signal in a format that is different from other ones of the base units. In various embodiments, and base station 820 is operable to transform these various and different formats into a single format that should be properly received and interpreted by one or more of the remote units 814A-C. Thus, in various embodiments, base station 820 is operable a to allow base units operating under different formats, or remote units operating under different formats, to operate as a system.

In various embodiments, a remote unit such as remote unit 814C is operable to communicate directly with a base unit when is connection is operational, as represented by arrow 825, and to communicate with a base unit through base station 820 when communications directly with the base unit is not operational.

FIG. 8B illustrates a positional monitoring system 850 according to various embodiments. Positional monitoring system 850 includes a base station 820 located at a high position over a geographical barrier 822. A geographical barrier is not limited by any particular type of geographical barrier, and includes any type of geographical barrier that would inhibit certain types of communication links, such as but not limited to certain types of communication carrier waves that would not be functional to travel across the geographical barrier 822. By way of illustration, certain frequencies of carrier waves have reduced or no ability to travel and to traverse geographical barriers such as hills, or to pass through water. In some instance, certain types of transmission such as infra-red and transmissions associated with commercial televisions broadcasts or commercial Frequency Modulation (FM) transmissions are limited to substantially a line-of-sight type transmission. By providing a base station 820 at a location 822 above geographical barrier 822, a remote unit 814A located on one side of the geographical barrier 822 is able to be communicatively link to a base station 812B on the opposite side of the geographical barrier 8722 through communications link 815A, base station 820, and communications link 840A.

By using a base station 820 to communicatively couple remote units and base station over geographic barriers, frequencies of signal that are useful with respect to the amount of bandwidth and information which the frequencies are capable of carrying but that have poor or inferior transmission characteristics with respect to terrain and range of transmission, can be implemented in communicative links 815 and 840 and still be operable to work over geographical barriers, such as geographic barrier 822.

The use of a compute hub 820 as illustrated in FIG. 8B allows for an extension of range over which the remote units 813A and the base station 812A can be communicatively coupled which using carrier frequencies or types of transmissions signals that would not operate over such a geographical barrier without the base station 820.

In various embodiments, base station 820 includes a solar panel or a solar cell, represented as device 890, and can derive some or all of its power requirements from device 890.

FIG. 8C illustrates another positional monitoring system 1800 according to various embodiments. In various embodiments, positional monitoring system 1800 includes a plurality of locational regions 1802A, 1802B, and 1802N. The number of locational regions is not limited to a particular number of locational regions, and positional monitoring system 1800 can includes more or less locational regions than shown in FIG. 8C.

In various embodiments, each locational region includes at least one base unit operable to receive positional information from at least one remote unit. By way of illustration, locational region 1802A includes a base unit 1804A that is operable to receive positional information from at least one remote unit represented by remote unit 1806A, locational region 1802B includes a base unit 1804B that is operable to receive positional information from at least one remote unit represented by remote unit 1806B, and locational region 1804N includes a base unit 1804N operable to receive positional information from at least one remote unit represented by remote unit 1806N. It would be understood that for any given locational region, it is not necessary that a remote unit actually be present within the locational region.

Further, it would be understood that for any given locational region, it is not necessary that the base unit be configured to receive positional information associated with a particular remote unit. In various embodiments, a base unit such as any given one or any combination of base units 1804A, 1804B, and 1804N can be selectively configured to receive positional information for any given remote unit, or from any one of a list of remote units, as further described herein. In various embodiments, a given base unit is normally associated with at least one remote unit, wherein the given base unit and the at least one remote unit were for example purchased as unit for use by the purchaser to allow the purchaser or other user to specifically track the at least one remote unit using the base unit. In various embodiments, the given base unit is normally configured to track a plurality of remote units, for example wherein the purchaser or other user of the given base unit has multiple subjects, such as but not limited to multiple dogs, which are intended to be trackable using the given base unit.

In various embodiments, a base unit is located at a fixed and non-mobile location. By way of illustration, base unit 1804A is located at house 1820A, and base unit 1804N is located at house 1820N. In various embodiments, the base units include an antenna physically coupled to the base unit, such as antenna 1808A coupled to base unit 1804A, and such as antenna 1808N coupled to base unit 1804N. In various embodiments, the base unit is coupled to an external antenna that is physically mounted to a fixed structure, such as antenna 1810A physically mounted to house 1820A, and antenna 1810N physically mounted to house 1820N.

In various embodiments, the base station in a locational region is a mobile device, such as but not limited to any one of the handheld units shown in FIGS. 11A-P. Referring again to FIG. 8C, base unit 1804B can be a mobile base unit operating in locational region 1802B. In various embodiments, base unit 1804B is communicatively coupled to a base station 1812 to extend the range over which base unit 1804B is operable to track remote unit 1806B, as represented by arrow 1817B. In various embodiments, since base unit 1804B is mobile, the area included within locational regions 1802B changes as the location of base unit 1804B changes, as represented by arrows 1819B. In various embodiments, the range represented by arrow 1817B and arrows 1819B is a plurality of miles, in some embodiments, 2-3 miles.

In various embodiments, the base units 1804A, 1804B, and 1804N are coupled to network 1830 through connections 1812A, 1812B, and 1812N respectively. Connections 1812A, 1812B, and 1812N are operable to allow communication of information, including positional information related to one or more remote units, between the base units and network 1830. In various embodiments, server 1850 is coupled to network 1830 through connection 1852. Connection 1852 is operable to allow server 1850 to be communicatively coupled to any of the base units 1804A, 1804B, and 1804N.

In various embodiments, server 1850 is coupled to database 1854 through connection 1856. In various embodiments, database 1854 is operable to store data that is accessible by server 1850, and is operable to store data provided to database 1854 by server 1850. In various embodiments, database 1854 stores data associated with one or more remote units, such as remote units 1806A, 1806B, and 1806N. In various embodiments, database 1854 stores positional informational related to one or more remote units 1806A, 1806B, and 1806N, including positional information over some period of time related to the one or more remote units. In various embodiments, database 1854 is operable to store positional information related to one or more base units 1804A, 1804B, and 1804N. In various embodiments, database 1854 is operable to store positional information related to the position of the one or more base units over some period of time, such as the positional information over a period of time for a mobile base unit, such as base unit 1804B.

In various embodiments, a mapping module 1860 is coupled to network 1830 through connection 1862. In various embodiments, mapping module 1860 is coupled directly to server 1850 over connection 1864. Mapping module is not limited to any particular type of mapping module, and includes any type of module operable to provide mapping information. In various embodiments, mapping module 1860 is a web based mapping function, such as but not limited to Google™ Maps. However, mapping module 1860 is not limited to any particular brand or type of mapping software or program, and includes any module operable to provide mapping functions to server 1850. In various embodiments, mapping information provided by mapping module 1860 is used in conjunction with positional information received at server 1850 to map one or more base units, one or more remote units, or any combination of one or more base units and one or more remote units.

FIG. 8D illustrates a diagram 1890 including a map 1892 indicating a position 1893 for a remote unit. In various embodiments, position 1893 is determined based on positional information received at server 1850, and diagram 1890 is generated by server 1850 using the received positional information and mapping information provided by mapping module 1860. In various embodiments, one or more locational regions 1894, and one or more base units 1895, are included in diagram 1890. In various embodiments, base unit 1895 is the base unit normally associated with tracking the remote unit who's position is indicated at position 1893. In various embodiments, server 1850 is operable to provide diagram 1890 over network 1830 so that diagram 1890 can be displayed at a user device, such as but not limited to any one of user devices 1870.

Referring again to FIG. 8C, in various embodiments, positional monitoring system 1800 includes one or more user devices 1870. In various embodiments, user devices 1870 include user device 1870A through 1870N as illustrated by dotted line 1870B. The number of user devices included in user devices 1870A-N is not limited to any particular number of devices, as illustrated by dotted line 1870B. User devices 1870 are not limited to any particular type or types of user devices, and can include any types of user devices operable to allow a user to access server 1850, including accessing server 1850 through network 1830. In various embodiments, user devices 1870 include any one, or any combination of, a personal computer, a laptop computer, a Personal Digital Assistance (PDA), and a cell phone.

In various embodiments, a user device 1870 includes a display, such as display 1876A of user device 1870A, and display 1876N of user device 1870N. In various embodiments, a display such as displays 1876A and 1876N are input/output devices operable to provide both visual output to a user, and to allow actuation of the display to provide inputs to the user device that includes the display. In various embodiments, a user device includes one or more input devices, such as but not limited to keyboard 1872 and computer mouse 1874, operable to allow a user to provide inputs to the user device to which the input device is connected.

In various embodiments, a user wishing to access the positional monitoring system 1800 can access server 1850 through network 1830. A user accessing server 1850 can provide credentials, such as a password, in order to establish authorization to view information and to request services related to positional monitoring system 1800 and related to remote units, as further described herein. In various embodiments, server 1850 is operable to provide tracking information, diagrams including maps and indications of locations on the maps of remote units, and alert massages, in any combinations of displays, text messages, and automated telephone calls sent to any combination of user devices 1870, all in view of the authorizations to receive and to view or to hear such information, as stored in database 1854.

In various embodiments, each locational region 1802A, 1802B and 1802N includes a nominal operating range over which the base unit included in the locational region can be expected to be able to receive any information transmitted by a remote unit. By way of illustration, base unit 1804A is within locational region 1802A, and can be expected to receive any information, including positional information, transmitted by any remote units within the locational region bounded by boarder 1816A. In various embodiments, base unit 1804A is specifically programmed to normally receive any positional information related to the position of remote unite 1806A, as base unit 1804A and remote unit 1806A are paired together as an operating unit.

Similarly, in various embodiments, base unit 1804B located within locational region 1802B can be configured to receive and process information related to remote unit 1806B within boarder 1816B, and base unit 1804N can be configured to receive and process information related to remote unit 1806N within border 1816N. Locational region 1802A is generally indicated by boarder 1816A and arrows 1819A, and is determined by the range limits of base unit 1804A being able to receive informational signals from, and in some embodiments to provide informational signals to, a remote unit. Locational region 1802N is generally indicated by boarder 1816N and arrows 1819N, and is determined by the range limits of base unit 1804N being able to receive informational signals from, and in some embodiments to provide informational signals to, a remote unit.

In various embodiments, the ranges indicated by arrows 1819A and 1819N are a plurality of miles in length, such as but not limited to a range of 2-3 miles. Locational regions 1802A, 1802B, and 1802N are not limited to being any particular shape with respect to their boarders, and can includes any closed geometrical shape, including shapes that are not symmetrical.

In various embodiments, boundary perimeters, as described herein, can exist within any given locational region. By way of illustration, a boundary perimeter 1818A has been established within locational region 1802A, wherein any of the features associated with a boundary perimeter, including alarm messages when a remote unit leaves the boundary perimeter (or enters the perimeter in the case of an exclusion zone) can be incorporated in with the boundary perimeter 1818A. In various embodiments, boundary perimeter 1818N is confined to an area within locational region 1802N and is associated with remote unit 1806N. In FIG. 8C, the size of boundary perimeters is not necessarily to scale with the size of the boundaries of the locational regions. In some embodiments, the lengths of the sides of the boundary perimeters is in feet, tens of feet, or less than 200 feet, wherein the range of the locational regions as illustrated by arrow 1819A, 1819B, and 1819N are in a plurality of miles.

In various embodiments, when a remote unit leaves a locational region having the base unit to which the remote unit is normally associated with, the base unit may no longer be able to received the positional information being transmitted from the remote unit. By way of illustration, if remote unit 1806A leaves locational region 1802A as illustrated by arrow 1822, base unit 1804A may no longer be able to receive the positional information being transmitted from remote unit 1806A. This may be due to the extended range of remote unit 1806A from base unit 1804A, or due to physical or geographical obstructions blocking the transmission of information from remote unit 1806A, as shown by the position of remote unit 1806A at the arrowhead end of arrow 1822. In various embodiments, base unit 1804B can be configured to receive positional information related to remote unit 1806A, and when remote unit 1806A enters locational region 1802B, base unit 1804B will receive the locational information transmitted by remote unit 1806A, and provide the information through network 1830 to server 1850.

In another illustration, remote unit 1806A moves to a location out of locational region 1802A, as illustrated by arrow 1824, but enters locational region 1802N. In various embodiments, base unit 1804N is configured to receive positional information being transmitted by remote unit 1806A, and when remote unit 1806A enters locational region 1802N, base unit 1804N is operable to receive the positional information being transmitted by remote unit 1806A, and to provide the information through network 1830 to server 1850.

In various embodiments, activation of one or more locational regions to detect information being transmitted from a given remote unit is communicated to a base unit within a given locational region from server 1850 through network 1830. The trigger to configure one or more base units other than the base unit or units normally configured to receive the transmissions from a given remote unit in not limited to any particular event. In various embodiments, a user device 1870 is used to communicate to server 1850 that a given remote unit needs to be located using one or more locational regions not already associated with the remote unit. In various embodiments, a remote unit exiting from a given boundary perimeter can trigger a message from the base unit normally configured to track the transmissions from the given remote unit to contact server 1850, and to request that server 1850 contact additional locational regions in order to configure the additional locational regions for tracking any transmissions from the given remote unit.

By way of illustration, if remote unit 1806A exits the area included within boundary perimeter 1818A, base unit 1804A can communicate to server 1850 a message including a request to have other locational regions, such as locational regions 1802B and 1802N, configured to look for and to receive and to provide any positional information transmitted by remote unit 1806A. Upon receiving the request from base unit 1804A, server 1850 is operable to configure one or more base units in one or more different locational regions, such as base units 1804B and 1804N in locational regions 1802B and 1802N respectively to receive information transmitted from remote unit 1806A, and to provide any such received information to server 1850.

In various embodiments, server 1850 is operable to configure individually the base units 1804B and 1804N so that the base units either do or do not display any tracking information associated with remote unit 1806A on the displays of the base units 1804B and 1804N. In this way, server 1850 can be used to network together a plurality of locational regions in order to track a remote unit over a range that exceeds the range over which the base unit normally associated with the remote unit could track the remote unit.

In various embodiments, server 1850 is operable to use mapping module 1860 and any positional information provided to server 1850 to map a location of a given remote unit, and to provide the locational information, including a visual display of the remote unit on a map, to a user device 1870 that is authorized to receive the information related to the particular given remote unit. In that way, a user who is associated with the particular remote unit, for example remote unit 1806A, can contact server 1850 and find out a location of remote unit 1806A, if available and that the user is authorized to obtain, using any location from which the user device can couple to network 130. In various embodiments, network 130 includes the Internet, so a user can gain access to any available positional information related to the remote unit the user is authorized to access from anywhere the user can connect to the Internet, or any other network included in network 1830.

In various embodiments, the one or more locational regions 1802A, 1802B, and 1802N includes a boundary perimeter, such as boundary perimeters 1818A and 1818N respectively, operable to “trap” a remote unit once the remote unit enters within the boundary perimeter. In various embodiments, trapping the remote unit includes providing a signal to the remote unit to actuate stimulation at the remote unit if the remote unit attempts to exit the area included within the boundary perimeter once the remote unit enter the particular boundary perimeter. By way of illustration, sever 1850 is operable to configure base unit 1804N to signal remote unit 1806A to provide stimulation once remote unit 1806A is detected within boundary perimeter 1818N and if remote unit 1806A tries to then exit boundary perimeter 1818N. In this way, the subject, such as a dog that is wearing a collar including remote unit 1806A and that has exited from its normal boundary perimeter 1818A, can be trapped by encouraging the dog wearing remote unit 1806A to stay within boundary perimeter 1818N by providing stimulation to the dog if the dog tries to leave boundary perimeter 1818N once the dog enter the area within boundary perimeter 1818N.

In various embodiments, server 1850 is operable to configure only certain locational regions to track or to trap a given remote unit based on information such as proximity of the locational regions to the locational region where the remote unit is normally associated with. By way of illustration, sever 1850 is operable to activate certain locational regions that are within a given distance of the locational region normally associated with a given remote unit when activation of additional locational regions is requested or desired. In various embodiments, server 1850 activates certain locational regions to track a given remote unit based on a last known position of a given remote unit.

In various embodiments, database 1856 is operable to store a mapping of user identifications to remote units so that a given user identification is associated with a given remote unit, and the user identification is operable to confirm that a user associated with the user identification, or providing the user identification information such as a password, is authorized to receive tracking information related to the remote unit associated with the user identification. In various embodiments, the user identification is used to determine if a user requesting that the server 1850 activate additional locational regions in order to track and provide positional information related to a given remote unit has been authorized to activate additional locational regions for the given remote unit.

In various embodiments, the server 1850 is operable to use the user identification information stored in database 1854 to determine if a user requesting trapping of a remote unit in a additional locational regions other than the locational region normally associated with the remote unit is authorized to activate trapping of the given remote unit. Thus, server 1850 is operable to authenticate requests received at server 1850 for various services related to particular remote units based on the mappings between user identifications and remote units stored in database 1854.

In various embodiments, server 1850 is operable to deny requests for positional information and for activations and other services related to a given remote unit when the request is received from a party that is not authorized to make these requests per the mappings stored in database 1854.

In various embodiments, database 1854 is operable to store mapping information related to which different locational regions are activated to receive information, including positional information, for which given remote units. In this way, server 1850 is operable to receive and process a variety of tracking information related to a plurality of remote units over a plurality of locational regions, to individually map the positional information related to the plurality of remote units using information provided by mapping module 1860, and to control access to the information and to grant requests for tracking information based on the authorization information stored in database 1854.

In various embodiments, positional monitoring system 1800 is operable to expand as additional base units and as addition remote units are added by adding information to database 1854 regarding the additional base units and the additional remote units. Thus, positional monitoring system 1800 provides an expandable network for tracking remote units over a wide and selectably configurable area.

FIG. 8E illustrates various embodiments of a fencing mode 1900. In various embodiments, mode 1900 includes a start position 1902, an end position 1904, and a course 1906 running between the start position 1902 and the end position 1904. In various embodiments, an object or a marker, such as a flag, is used to indicate start position 1902. In various embodiments, a marker of some type, such as but not limited to a flag, is used to indicate the end position 1904. In various embodiments, course 1906 is a visible course, consisting of, for example, a string laid on a surface such as the ground. In various embodiments, a visible course is made using a colored pigment, such a paint or colored dust such as chalk, and is applied to a surface, such as the ground or a floor, to indicate the course 1906.

In various embodiments, perimeter 1910 defines a perimeter fence that includes an area surrounding start position 1902, course 1906, and end position 1904. In various embodiments, a distance 1912 determines the spacing between perimeter 1910 and each of start position 1902, course 1906, and end position 1904. However, embodiments of mode 1900 are not limited to having a same distance between the perimeter and any of the start position 1902, the course 1906, and the end position 1904. Perimeter 1910 can include various distances, for example from course 1906, at various positions along course 1906.

In various embodiments, distance 1912 can be several yards, for example 20-30 yards. In various embodiments, distance 1912 is a plurality of feet. In some embodiments, distance 1912 is no more than 10 feet.

Perimeter 1910 can be established by any of the techniques and methods described herein, include using a base unit 1917 in a fence mode to establish the positions of perimeter 1910.

When in operation, a tracked subject 1915 wearing or otherwise having a remote device, such as a dog wearing a collar including the remote device as described herein, can be trained to move along a path defined by course 1906 and as represented by arrow 1903. By way of illustration, the tracked subject can be positioned at start position 1902, and directed to follow course 1906 to end position 1904. If the tracked subject veers off course and crosses perimeter 1910, the base unit 1917 tracking the tracked subject 1915 can signal the remote device to provide stimulation, such as an audio beep, or electrical stimulation, to indicate to the tracked subject that they are veering off course. In this way, for example, a dog can be trained to “run a line” from start position 1902 to end position 1904, for example as part of obedience training, police dog training, or training a dog to retrieve. The perimeter 1910 can also be used to persuade the tracked subject 1915 to return directly back from the end position 1904 to the start position 1902 along course 1906.

In various embodiments, course 1906 could be an non-visible course, wherein a tracked subject, such as a child or a person would move away from start position 1902 and as they intersect perimeter 1910, the remote device they are carrying produces a stimulation, such as an audio tone, indicating that they are off course. By constantly moving and listing for the “off-course” indication, the tracked subjects can use the remote device to navigate, for example, as part of a game, to find their way to the end position 1904. In various embodiments, course 1906 is not a strait line, and can include curves, turns, and can be routed over various terrain and obstacles, such as a wall, in order to add interest to the game of reaching the end position 1904. Such embodiments are operable for conducting different types of contests based on individuals or teams competing for a best time to reach the end position 1904, or for search games that lead to prized, such as in a geo-caching games.

In various embodiments, since the position of the remote device can be regularly determined and sent to a base unit 1917, the game played can include determining a person's or a team's score when running course 1906 by the accuracy to which the person or team followed course 1906, including the number of times the person or team penetrated perimeter 1910. In various embodiments, the least number of penetrations outside perimeter 1910 would result in the most desirable scoring for any particular person or team running the course.

In various embodiments, mode 1900 includes perimeter 1910 as a first fence perimeter, and further includes a second fence perimeter 1920. In various embodiments, the second fence perimeter 1920 is a distance 1914 outside perimeter 1910, and further away for start position 1902, course 1906, and end position 1904 than the first fence perimeter 1910.

In various embodiments, when a tracked subject veers off of course 1906 and crosses fence perimeter 1910, a first type of stimulation, for example an audio beep, is provided at the remote device. If the tracked subject returns to course 1906, the first type of stimulation is removed. If after crossing the first fence perimeter 1910 the tracked subject continues to veer off course and then crosses the second fence perimeter 1920, the remote device can provide a second and different kind of stimulation, such as electrical stimulation. In this matter, a tracked subject such as a dog can be provided a warning that they are veering course by the first type of stimulation, and then if they continue to veer further off course 1906, they are provided with the second type of stimulation. Thus, the tracked subject can learn to avoid the second type of stimulation by returning to the course 1906 whenever they are provided with the first type of stimulation.

It would be understood that course 1906 need not be a visible course in all embodiments. In various embodiments, course 1906 would be understood to be a straight line between start position 1902 and end position 1904, regardless of whether course 1906 included a visible or a non-visible course. In the illustration described above where course 1906 is used as part of a game, course 1906 would, in many instances, be a non-visible course, wherein the purpose of the game is to use the stimulation provided at the remote device in order to discover the proper course.

In various embodiments, a non-visible course include is an course that is not indicted by some type of condition that is visible recognizable by the tracked subject attempting to follow the course. In various embodiments, a non-visible course is a course determined by some characteristic, such as a scent trail, the is not visible to a tracked subject attempting to travel along the course, but that could be recognized by some other sense such as the sense of smell. In such embodiments, an animal such as a dog, attempting to travel along the course could be provided stimulation, such as an audio beep, if the animal veers too far off the course while following a scent trail. Such embodiments can be useful to help train police and rescue dogs for different tasks these dogs are expected to perform.

In some embodiments, mode 1900 is operable to allow switching between one or more different fence parameter in order to encourage a particular behavior on the part of a tracked subject. By way of illustration, a dog being trained to retrieve an item placed at end position 1904 leaves start position 1902 and travels along course 1906 before arriving at end position 1904. Once at end position 1904, the dog picks up the item to be retrieved, but then refuses to return to the start position 1902, i.e., the dog will not bring back the item being retrieved from the end position 1904. In various embodiments, an operator using base unit 1917 can switch to another fencing perimeter, represent by arrow 1924 and first new perimeter end line 1922, wherein the start position 1902 and the portion of the course 1906 to the left of first new perimeter end line 1922 are still within the area defined by the new fence perimeter, but end position 1904 is now external to the are defined by the new perimeter. Because the dog is now outside the area defined by the new perimeter, the remote device can be signaled to provide stimulation to the dog, wherein the stimulation ends when the dog moves back across the first new perimeter end line 1922 and along course 1906. The process can be repented by again changing the area included in the fencing perimeter to a fencing perimeter having another end line perimeter, represented by arrow 1927 and a second perimeter end line 1926. By successively moving the new perimeter end lines back toward the start positions 1902, and by providing stimulation at the remote device whenever the dog is outside the area of the fence perimeter as it changes, the dog can be trained to return to the starting position after arriving at the end position 1904 and after picking up the item at the end position 1904 that is to be retrieved.

FIG. 8F illustrates various embodiments of a fencing mode 1950. In various embodiments, mode 1950 includes a starting position 1952, and end position 1954, and a course 1956 running between the starting position 1952 and the ending position 1954. In various embodiments, course 1952 is a winding or curved course that weaves back and forth around one or more markers 1958 and 1959. Markers 19568 and 1959 are not limited to any particular types of markers, and include flags, barrels, 55-gallon drums, and posts that are either self standing or that can be partially extending into the ground where the post is located. In various embodiments, markers 1958 and 1959 are natural objects such any combination of objects such as rocks and trees.

In various embodiments, course 1956 passes around marker 1958 on a first side, as indicated by arrow 1962, and passes around marker 1959 on a second side, as indicted by arrow 1964, and then extends to end position 1954 as indicated by arrow 1966. It would be understood that course 1956 can also include moving in the direction from end position 1954 back to start position 1952 along course 1956.

In various embodiments, a fence perimeter 1970 is established in mode 1950 to form a perimeter around start position 1952, course 1956, and end position 1954. Fence perimeter 1970 can be established using any technique or method descried herein, including using a base unit 1957 to establish fence perimeter 1970. In various embodiments, the distance between fence 1970 and various markers along course 1965 is specifically designed to prevent passing along a particular side of a given marker when attempting to traverse course 1956. By way of illustration, point 1972 along fence perimeter 1970 is close or actually in a same space as marker 1958 so that a tracked subject can pass by marker 1958 along course 1956 without penetrating fence perimeter 1970, but cannot pass around the side of marker 1958 opposite course 1956 without penetrating fence perimeter 1970. Similarly, a tracked subject can pass along marker 1959 on the side of marker 1959 indicted by course 1958 without penetrating fence perimeter 1910, but cannot pass around marker 1959 on a side of marker 1958 opposite course 1956, as indicated by position 1974 on fence perimeter 1970, without penetrating fence perimeter 1970.

In various embodiments, if a tracked subject is attempting to travel along course 1956 and veers off course 1956 enough to penetrate fence perimeter 1970, stimulation, such as but not limited to an audio beep or beeps, can be provided at a remote device the tracked subject is physically coupled to. In various embodiments, mode 1950 can be used to train animals, such as dog or horses, to run courses including markers according to a pre-determined course. Such training is useful for training these animal for such things as obedience type competitions, wherein the animals are scored on their ability to run an pre-determined course. In addition, these embodiments, can be using for training horses for competition such as rodeo barrel riding, wherein a horse and a human rider are scored based on time and their ability to travel over a pre-determined course that includes markers such as barrels.

Mode 1950 could also be used to help train for such sporting events as downhill snow skiing, wherein a skier is required to weave a pre-determined course around a set of markers. Since the skier is constantly looking ahead as they ski down the hill, the use of audible stimulation, such as an audible beeper at a remote device being carried by the skier, allows the skier to continue to visually focus on the course ahead while at the same time receiving audible stimulation indicating whether they are off course. It would be understood that use of tracking systems described herein in sporting events in not limited to skiing, and is contemplated as useful in any sporting events and other activities where positional information can be useful in any aspect of the event or activity.

In various embodiments, any of the tracking modes described herein, including mode 1900 and 1950, can be used to track and score participants, including dogs, horses, and humans, during any type of activity based the participant's execution of following a pre-determined course. In various embodiments, no stimulation or fencing mode is utilized is such an activity, and one or more remote units are used in conjunction with one or more base units to simply track the various participants involved in the activity and to determine a score based on the participant's ability to travel along and to adhere to a predetermined course.

In various embodiment, positional information regarding any given participant includes time information related to the participants, and so the tracking modes can not only be used to determine accuracy in following a pre-determined course, and are also operable to provide time information for a given participant, including a time of arrival for a given participant at a given destination, such as an end position. In various embodiments, the tracking modes are operable to provide an overall time used by any given participant to travels a course from a start position to an end position.

Any of the various embodiments for tracking system described herein can incorporated in a “quiet dog” mode, wherein the tracking system is operable to determine if a tracked subject, such as but not limited to a dog wearing a remote device, is currently moving or is stationary. In various embodiments, a tracked subject is considered to be stationary when the transmitted positional information transmitted from the remote device physically coupled to the tracked subject has not moved more than some maximum distance in any direction from a given positional location with a minimum time period. By way of illustration, if a remote device transmits locational information that indicates that the remote device has not moved more than four feet in any direction for a time period of at least five seconds, the remote device is considered to be stationary. The quantity used as the maximum distance moved, and the quantity used as the minimum time period are not limited to any particular values, and can be set to different values deepening on the nature of the subject being tacked, the positional accuracy and any errors present in the positional information being transmitted form the remote device.

In various embodiments, motion sensors included in the remote device are used to determine if the remote device has or has not moved within a given minimum time period, and the remote device is operational to transmit a signal to a base unit indicating that, based on the motion sensors, the remote device has not moved within at least some minimum time period.

A determination that a remote unit is stationary is not limited to any particular method of determining the status of the remote derive as being stationary, and is not limited to the illustrative techniques or methods described above. A determination that a remote device is stationary can be made using any technique or method, or any combination of techniques and methods that are operable to determine positional information of a remote device using the tracking systems described herein.

In various embodiments, when in quiet dog mode and the tracking system determines that a tracked subject associated with a remote device is stationary, various embodiments, include an alert being actuated at a base unit, such as but not limited to, base unit 200 as shown in FIG. 2A. In various embodiments, the alert indicates that the a remote device being tracked by a base unit is stationary. In various embodiment, the stationary status of a remote device is indicated using a audible beep proved by, for example, audio output device 205E as shown in FIG. 2A. In various embodiments, the stationary status of the remote device is indicated at a base unit visually. By way of illustration, base unit can indicate a stationary status of a remote device being tracked by having a graphic symbol on the display of the base unit that represents the remote unit being track flash on and off whenever the remote device being tracked is determined to be stationary.

The quiet dog mode is useful for determining if for example a hunting dog while hunting is not moving, and therefore is most likely “pointing” a game bird or other game. The quiet dog mode can also be used to determine if a dog is, for example, sitting, or possibly sleeping.

### System Detail

According to one example embodiment, the system is made up of a single base unit and one or more remote units. The user manipulates the base unit to determine the location of the remote units, the direction from the user, the speed and heading of the remote unit and the distance to the remote unit from the base unit.

The following features may be available according to one or more embodiments of the inventive subject matter:
A base unit may be a portable battery operated device.
A remote unit may be a portable battery operated device.
The base unit may provide 24 hours of service under nominal usage conditions.
The remote unit may provide 72 hours of service under nominal usage conditions.
The base unit may provide a LCD screen for the user interface.

### Remote Units

The remote units may be attached to the objects to be tracked. The remote units need to be small and relative light so that it can be attached to smaller pets. The remote unit may consist of a battery, a GPS module, and a RF module. The battery may include a charger or a charging circuit. The battery on the remote unit may be charged with an external power supply using a universal or custom connector according to some embodiments of the inventive subject matter. The system intelligence for the remote unit may be placed in the RF module.

The following features may be available according to one or more embodiments of the inventive subject matter:
The remote unit may be enrolled with only a single base unit at a time.
The remote unit may support reenrollment.
The remote unit may support 1 or more frequency for reporting GPS coordinates to the base unit.
The remote unit may send the GPS X, Y, Z to the base unit at regular intervals while it is active.
The remote unit may send the battery status to the base unit at regular intervals while it is active.
The remote unit may support a battery saver mode to preserve the battery life once the battery has less than a certain life left.

### Base Unit

According to one example embodiment, the base unit is similar to a PDA (Portable Digital Assistant) in size, weight and portability. The base unit may contain a LCD screen, a number of buttons, and internally, GPS and RF modules. The base unit has the capability of determining its GPS location, communicate to the remote units through a RF link, determine and display a compass heading, generate a tone, display location information of the active remote units on a LCD screen, and take user input through pushbutton keys.

Through the course of operation, the user may be presented with several modes of operation. When the unit is powered on, the user may be presented with the startup mode. During the startup mode, the base unit is acquiring a GPS lock, and determining which remote units are powered on and within range.

The tracking mode is the mode where the remote units are tracked. In this mode, information is gathered from each active remote unit through the RF module, and displayed on the base unit LCD screen. The position of the remotes is displayed relative to the position of the base unit.

Fence definition mode is used to define a perimeter that is based on a collection of GPS waypoints. The user can monitor the fence building process by viewing the LCD screen. The base unit uses the GPS coordinates that it collects to build a geographical fence.

Enrollment mode is a mode that allows the user to pair a remote unit with the base unit. Once this pairing is performed, the base unit can track the remote unit. Otherwise, the base unit ignores the presence of the remote unit.

The base unit firmware may provide modes of operation that keeps the user informed of progress during the base units GPS first fix operation, normal tracking and locating operation, while building an electronic fence, and while the user enrolls remotes to the base unit.

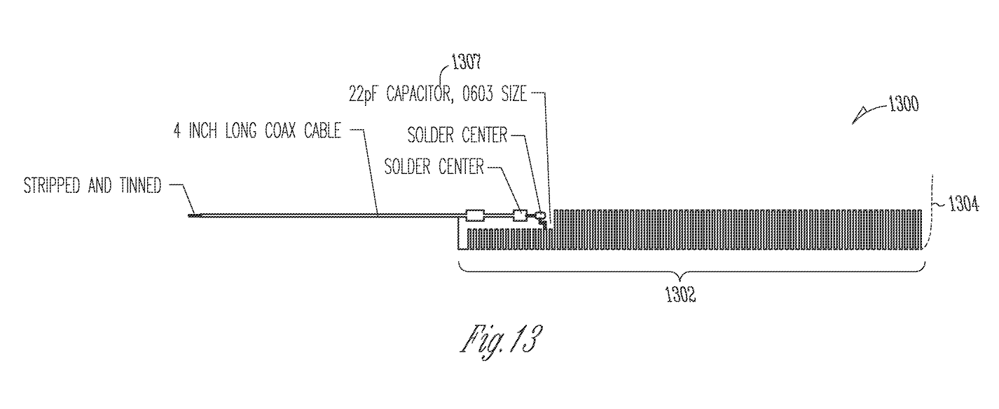

FIG. 9 illustrates one or more of Operational Modes 900 of a base unit. In various embodiment, the base unit is any base unit described herein, including but not limited to base unit 12 of system 10 as shown in FIG. 1.

In various embodiments, Operational Modes 900 include any combination of the following:

Startup Mode 930;

Tracking Mode 932;

Fence Definition Mode 934;

Search Mode 936; and

Enrollment Mode 938.

In various embodiments, fence definition mode 934 includes either or both a Perimeter Definition Mode 934A and an Exclusion Zone Mode 934B. Modes of operation 900 are further described herein.

### Startup Mode

With reference to the operational modes laid out in FIG. 9, when the user powers on the base unit, it may enter startup mode 930. In startup mode 930, the base unit may attempt to acquire a GPS fix, and determine which remotes it can communicate with. Initially, the startup mode may display a splash screen. This splash screen may help “brand” the base unit and welcome the user.

Upon power on, the base unit may display a splash screen (or sequence of screens) for a desired number of seconds.

Once the splash screen has been displayed, the user may be given a visual indication, through the use of an icon, the status of the initial GPS fix.

After the splash screen has been displayed, the status of the initial GPS fix may be displayed. Until a valid initial GPS fix has been obtained, an acquiring GPS fix icon may be displayed.

The startup screen may also display a status bar on the LCD screen. While the GPS module in the base station is attempting to acquire an initial GPS fix, the base station may determine which units are powered on and within range. The remote units found to be turned on and in range may be displayed as active in the status bar. The initial GPS fix status of the remote units found may also be displayed. To aid the user in the determination of the remaining battery life of the remote unit, a battery icon may accompany the remote unit icon.

The following features may be available according to one or more embodiments of the inventive subject matter:
In startup mode 930, the base unit may determine which bonded remote units are powered on and within range. Those bonded remote units found and within range may be displayed.
The remote units displayed in the wayside rest are may contain an acquiring GPS fix icon while the corresponding remote unit is acquiring the initial GPS fix.
Each remote unit displayed may contain a battery icon that provides an indication of remaining battery life. The battery icon may contain 0, 1, 2, or 3 bars corresponding to <15%, from 15% to <50%, from 50% to <85%, >85% respectfully. According to an alternative embodiment, the battery icon may contain 0, 1, 2, or 3 bars corresponding to <25%, from 25% to <50%, from 50% to <75%, >75% respectfully, or other combinations of battery life percentages.
Each icon displayed for the remote units may be unique as to allow the user to differentiate between them. The same icon for a remote unit must be used from one use session to the next.

Once the base station has acquired an initial GPS fix, the startup mode 930 has been completed and the base station operation may proceed to the tracking mode screen without further user intervention.

Once the initial GPS fix for the base station has been established, operation of the base station may continue in the tracking mode 932.

### Tracking Mode

With reference to the operational modes laid out in FIG. 9, tracking mode 932 provides the user with direction, distance, velocity, and other status of the remote units being monitored.

The tracking screen contains a relative overall view of the base station and the remote units. The base station may be centered, with the remote stations displayed relative to their position. The built in compass may be used to rotate the remote units on the screen such the physical direction corresponds to the screen position. This provides a more natural interface such that the user doesn't have to translate the direction on the screen to a real world direction.

The following features may be available according to one or more embodiments of the inventive subject matter:
When fully zoomed in, the portion of the screen devoted to the tracking of the remote units may cover 150 feet along the X or Y axis, whichever is the smaller dimension.
When fully zoomed out, the portion of the screen devoted to the tracking of the remote units may cover 7500 feet along the X or Y axis, whichever is the smaller dimension.
A pair of physical switches may control the level of zoom in or zoom out.
The level of zoom in or zoom out may be communicated to the user on the LCD screen.
The tracking screen may rotate to maintain the compass bearing.
The compass bearing may be checked a number of times a minute.
According to one embodiment, the compass bearing may be checked once every second.
The remote units may be displayed in the tracking area scaled from the base unit, and position by compass bearing taking the current compass bearing into account.

In general, it is easier for the user to relate to positions of objects with respect to themselves. To aid in use of the base station, the base station may be placed in the center of the tracking screen with the remotes units in their corresponding positions around it.

The user may be provided with the ability of creating and using an electronic fence. This fence may be defined in GPS coordinates. The user will have the ability of turning on and off the electronic fence. When appropriate, the electronic fence may be displayed in the tracking screen, scaled and rotated as appropriate. When the electronic fence is turned on, the user may be given an alarm when one or more remotes approach or pass through the electronic fence.

The following features may be available according to one or more embodiments of the inventive subject matter:
The electronic fence may have, and be displayed with a width that may compensate for the GPS inaccuracies.
The state of the electronic fence may be saved between sessions. If the electronic fence is turned off when the base unit is powered off, when turned back on, the electronic fence may remain off. Likewise, when the electronic fence is turned on when the base unit is powered off, it may be turned on when the base unit is powered on.
The electronic fence may display an indication in the tracking area of the LCD screen showing where the fence is, providing that the zoom factor allows it.
When the electronic fence has been turned on, an electronic fence icon may be displayed. When the electronic fence has been turned off, an electronic fence icon shall not be displayed.
If the user attempts to be turn on the electronic fence when one has not been defined; an alert may be presented to the user.
When one or more of the remotes approach and pass through the electronic fence when it is turned on, the user may be presented with an alert.

When the scale of the tracking screen is such that one or more remotes can no longer be drawn within the confines of the screen, the PIP mode for those remotes off the screen may be invoked. The remote icon may change to an arrow. This arrow may be pinned to an edge of the screen and may point from the base unit to where the remote unit would be displayed of the physical screen were large enough to contain it.

According to an alternative embodiment. the PIP may be shown in one of eight positions around the perimeter of the tracking screen. These PIP screens may be used to track the remotes that have left the screen (at the current scaling). The remote that is off the screen may be displayed in the one of eight PIP locations that most closely maintains it relative position. While the PIP is on the screen, it may be semitransparent to allow any other remote being track, and under the PIP, to still be seen by the user. In the PIP, the base station may be either centered along the line, or the corner, whichever is closest to the center of the tracking screen. The scale from the PIP base station icon to the closest edge of the tracking screen may be such that it allows for the full range of the remote. To aid the user in the determining which remote is in the PIP and which may be under it, the icons contained in the PIP may be smaller than those used on the tracking screen.

### Fence Definition Mode

With reference to the operational modes laid out in FIG. 9, according to another example embodiment, the method and apparatus of the inventive subject matter may allow the user to define an electronic fence utilizing a fence definition mode 934. In various embodiments, Fence Definition Mode 934 includes a Perimeter Definition Mode 934A, wherein the electronic fence is used to provide a perimeter that when a remote unit approaches and breaches the electronic fence, a warning is issued to the user. The electronic fence is defined by a set of GPS coordinates. Before the electronic fence can be used, the user must first define the fence.

In various embodiments, fence definition mode includes an Exclusion Zone Definition Mode 934B, wherein one or more exclusion zones are defined by defining an exclusion zone boundaries. In various embodiments, the defined exclusion zones are either completely or partially within an perimeter defined in the Fence Definition Mode 934. While the description includes various descriptions related to the definition of a perimeter fence, any techniques and method used to define a perimeter fence can be used to define an the boundaries of an exclusion zone.

The following features may be available according to one or more embodiments of the inventive subject matter:
When shipped, the base unit may not contain any electric fence definitions.
The base unit may support a number of electronic fence definition at a time.

To use the fence definition mode 934, the user may define or redefine the electronic fence by pressing the option and create fence buttons simultaneously, slowly walk the fence perimeter, using the fence button to create a fencepost, and pressing the option and create fence buttons again. Since the fence is defined using GPS coordinates, the user may define the fence once the initial GPS fix has been accomplished. The user should be kept informed of the progress of the operation by displaying the portion of the fence currently defined and the number of fence posts that are stored in memory.

The following features may be available according to one or more embodiments of the inventive subject matter:
The fence may only be defined when the base unit is in the tracking mode 932.
When in tracking mode 932, the fence definition mode 934 may be entered when the option and fence button are pressed simultaneously.
Alternatively, fence definition mode 34 may be entered by pressing a define fence button.
Once in fence definition mode 934, exit back to tracking mode 932 may be made when the option and fence button are pressed simultaneously.
When in fence definition mode 934, GPS coordinates are collected when fence posts are defined by pressing the fence button and are used to create the electronic fence.
The current progress of the fence definition may be displayed on the LCD screen along with the indication of the GPS lock and the number of fence posts defined.
When exiting from fence definition mode 34 into tracking mode, the electronic fence shall be turned on.

### Search Mode

With reference to the operational modes laid out in FIG. 9, search mode 936 may optionally be used to aid the user of the base unit find one or more of the remote units. To preserve power, the remote units may only occasionally transmit their location. When in search mode 936, the remote units may transmit their position more frequently.

The following features may be available according to one or more embodiments of the inventive subject matter:
The base unit may support a search mode 936.
This search mode 936 may request all the remote units to return their
GPS coordinates at a more frequent than normal rate.

An additional feature of search mode 936 is to allow additional base stations join the search. When additional base units join the search, those units may suspend tracking of their remote units and may start tracking the remote units of the target base station.

### Enrollment Mode

With reference to the operational modes laid out in FIG. 9, before the base unit may communicate with to the remote units, an enrollment mode 938 may be entered in order for an enrollment process to take place. Once enrolled, the remote units and the base units are allowed to communicate with one another. The user may enroll a remote unit into one of a number of separate slots. The user may select which of the slots to use by pressing the corresponding enrollment button. The user may be allowed to reenroll the unit into a different slot, removing it from the previous slot.

The following features may be available according to one or more embodiments of the inventive subject matter:
The base unit may allow a remote unit to be enrolled into one of one or more slots.
The enrollment mode 938 may be entered/exited by simultaneously pressing the option and enrollment buttons. Alternatively, the enrollment operation may be available during the startup mode.
The base unit may allow a previously enrolled remote to be reenrolled into the same or a different slot. If it is reenrolled into a different slot, the remote is removed from its previous slot.
The base unit may indicate a successful enrollment operation by illuminating a LED once the enrollment operation has been successful concluded and may extinguish it once the enrollment button is released. If the enrollment operation is unsuccessful, the LED may not be illuminated.

### Example Implementation

The following represents detailed descriptions of features and functions according to one or more example embodiments of the inventive subject matter. The following is not meant to limit the previous sections or the claims, it is provided as a detailed disclosure of a practical implementation according to one or more embodiments of the inventive subject matter. Various alternatives are available according to other embodiments of the inventive subject matter.

According to one example embodiment, there is provided a RF Module designed to provide RF communication for the “Base” and “Remote” products. The RF module hardware for the base and remote is very similar. The firmware has significant differences, as the module on the remote must communicate to the GPS module and the module on the Base must communicate to the Base processor.

Remote

The RF module on the remote performs the following functions:
Receive commands from the base over the RF link. These commands put the remote in different “modes”. These modes include various update rates and sleep modes.
Configure the GPS module to the correct TricklePower settings for best battery life, based on the mode requested by the base.
Poll the GPS module for GPS position data.
Communicate GPS position data to the base over the RF link according to the current update rate.
Monitor the battery level and communicate it to the base as part of the normal updates.
Monitor a momentary switch for enrollment packet transmission.

Base

The RF module on the base performs the following functions:
Transmit commands to the remote over the RF link. These commands put the remote in different “modes”. These modes include various update rates and sleep modes.
Communicate with the host processor over the UART connection. This communication allows the host to put the RF module in various states, enroll or delete remotes from the RF module, put enrolled remotes in various modes, and request data from the RF module relating to enrolled remotes.
Keep track of latest position data from all enrolled remotes.
Optionally keep a list of “emergency” remotes and provide a means of communicating the IDs of these remotes to other bases.

### RF System Operation

Physical Layer

The link between RF modules operates on one of the five MURS channels. The frequency and bandwidth are as follows:

| Band | Frequency | Bandwidth |
|---|---|---|
| MURS Chan 4 | 154.600 MHz | 20 kHz |

In various embodiments, other frequencies are used as designated, for example, by the laws and regulations of the country where the systems are being operated.

The MURS bands allow 2 watts maximum transmit power. This, along with the favorable propagation characteristics of these frequency bands, allows for significant range.

Manchester encoding is used to encode the RF packet data. The narrow bandwidth requirements of the MURS bands forces a slow RF data rate of 2.777 kbps. The RF data is modulated on the carrier in an FSK manner with a deviation of approximately 5 kHz.

RF packet length from remote to base is approximately 78 ms. RF packet length from base to remote is approximately 41 ms.

Channel Usage

Channel usage may be on a random basis. Remotes that are updating on a certain schedule (every 2 seconds, for example) may dither their random transmissions around the 2-second tick. The average time between packets may be 2 seconds, but the actual time between any 2 packets may vary randomly. Any device that wishes to transmit, remote or base, may first check to see if the channel is being used by another device in range. If so, the transmission is postponed for a random wait period, at which time the device may try again. The base and remote may each keep their receivers on anytime they are not transmitting.

Remote Operation

Modes

The remotes send GPS position updates to the base at regular intervals. The interval is configured by the base by transmitting to the remote. The minimum update interval is 2 seconds. Each separate update rate is defined as a different remote “mode”. The remote also has an inactive mode, in which it does not transmit at all. During all modes, the remote has its receiver on to listen for new commands from the base.

The remote may decide to automatically drop down to a lower update rate if there has been no movement of the remote since the last update. The method for determining whether the remote has moved is TBD.

Immediate Update

The user may request an immediate update in GPS position for one of the remotes. In this case, the host tells the base RF module to command that remote to go to the fastest update rate, which is every 2 seconds. Upon reception of this command, the remote enters 2 second update mode, asks the GPS module for a new fix, and transmits the new fix back to the base on the next opportunity. The best case response time for the immediate update is 2 seconds, and the worst case is 4 seconds.

Enrollment

The base radio module is capable of enrolling up to three remotes. Each remote is enrolled by its 24 bit random ID, and is given a unit number by the base, ranging from 0-2. Enrollment is accomplished by putting the base module in a special enrollment mode via the user interface, then causing the remote to transmit a special enrollment packet by holding a momentary switch down for three seconds. Alternatively, the option and enrollment buttons may be held down to accomplish enrollment.

Enrollment is a three packet process. The first packet from the remote is asynchronous, occurring when the momentary switch has been down for three seconds. If the base hears the enrollment packet from the remote and is in enrollment mode, it may transmit a response. This response is on the correct time slot for the unit number the base may enroll the unit into. Upon reception of the response, the remote stores its new unit number and operation mode, and transmits its acknowledgement. Only upon reception of the acknowledgement does the base enroll the remote. This ensures that the remote is only enrolled into the base if it has the correct unit number and avoids issues with multiple remotes having the same unit number.

The base module may allow a particular remote to be enrolled in only one slot. If enrollment is attempted again for the same remote, the base module may perform the requested enrollment but may delete any other enrollment of the same unit. The base module allows remotes to be enrolled over the top of other remotes, and also allows for the host to delete all enrolled remotes.

In addition to the three normal units, each base module allows for the enrollment of three emergency units. These units are enrolled via a special process of transferring the normal units from one base module into the emergency units of another base module over the RF link. The user interface on the receptor base is used to put the RF module in “emergency unit enroll mode”. The user interface on the transmitting base is used to instruct the RF module to transmit its units over the RF link.

The host may instruct the base radio module to exit enrollment mode unconditionally. There is also a command that allows the host to query the base radio during enrollment mode. If an enrollment has occurred, the base radio informs the host and exits enrollment mode. If an enrollment has not occurred, the base radio informs the host and stays in enrollment mode.

### RF Module Electrical Specifications

General

| PARAMETER and CONDITIONS | UNITS | MIN | TYP | MAX |
|---|---|---|---|---|
| Supply Voltage | V | 3.1 | | 4.2 |
| Current Consumption (receive mode) | mA | — | 30 | |
| Current Consumption (transmit mode) | mA | — | 1000 | |
| Current Consumption (shutdown mode) | mA | — | .1 | |
| UART Data Rate | kBAUD | | 9.6 | |

RF Receiver

| PARAMETER and CONDITIONS | UNITS | MIN | TYP | MAX |
|---|---|---|---|---|
| RF Reception Frequency | MHz | — | 154.6 | — |
| IF Frequency | MHz | | 10.7 | |
| IF Bandwidth | kHz | | 30 | — |
| Sensitivity (direct injection from a | dBm | — | −114 | −107 |
| 50 Ohm source, antenna not installed) | | | | |
| Dynamic Range (direct injection from | dBm | 20 | 25 | |
| a 50 Ohm source, antenna not | | | | |
| installed) | | | | |
| Open Air Range | Feet | 5,000 | 7,000 | — |

RF Transmitter

| PARAMETER and CONDITIONS | UNITS | MIN | TYP | MAX |
|---|---|---|---|---|
| Frequency Range | MHz | — | 154.6 | — |
| Frequency Deviation | kHz | 3 | 5 | — |
| Output power (into 50 Ohms, antenna | dBm | 27 | — | 33 |
| not installed) | | | | |
| Transmit duty cycle, Remote | % | | | 3.9 |
| Transmit duty cycle, Base | % | | .01 | 4.1 |

### Mechanical Specifications

Board

| CHARACTERISTIC | DESCRIPTION |
|---|---|
| Size | 1.775 in × 1.25 in |
| Material | .0625″ FR4 |

External Connections

| TERMINAL | DESCRIPTION | EXTERNAL CONNECTION |
|---|---|---|
| 1 | LED | Connection to anode of LED on external board, |
| | | through resistor on external board. |
| 2 | +3 V | Used for in-circuit programming, no connection |
| | | to external board |
| 3 | +Vbatt | Direct connection to battery |
| 4 | MCLR/MOM_SW | Used for in-circuit programming, connection to |
| | | momentary switch to ground on external board |
| 5 | UART_RX | Direct connection to UART_TX on external |
| | | board |
| 6 | UART_TX | Direct connection to UART_RX on external |
| | | board |
| 7 | GND | Direct connection to GND on external board |
| 8 | 1 pps | Direct connection to 1 pps signal on external |
| | | module |

### Production Configuration and Testing

Microcontroller Programming

The Microchip PIC18LF1220-I/SS Microcontroller is used on the RF module. This part may be programmed either before assembly or in circuit. There may be two different firmware versions, one for the base module and one for the remote module.

Functional Testing

The test fixture may communicate with the DUT by connecting to its UART lines. It may also have control of a test radio. The following procedure may be used to test the boards. The procedure is identical for base or remote radio boards.

Enter Test Mode

The DUT may enter test mode when reset with its momentary switch input held low. This is pin 4 of the connector, and TP6 of the board.

Dump Unique ID

EEPROM locations in the DUT microcontroller hold the unique 24-bit ID for the module. These locations must be programmed to random values by the test fixture. This occurs over the serial interface. The interface may use a standard UART communication format of 9600 baud, 8, N, 1. The command used to transfer the 24-bit ID to the DUT is a 4-byte command as follows, where ID1 is the most significant byte of the ID and ID3 is the least significant byte:
0x7
ID1
ID2
ID3

When the DUT receives this command, it may store the received ID in RAM. There may be no response back to the test fixture, and the ID may not be written to EEPROM at this time.

Send RF Packet to DUT

The test fixture may send an RF packet to the DUT. This packet is a special packet that may be recognized by the DUT when it is in test mode. Upon reception of this packet, the DUT may write the current ID residing in RAM to EEPROM.

Release Test Mode

The test fixture may release the test pin (TP6). The DUT may detect this release. If the DUT received the special RF packet from the test fixture while it was in test mode, it may read its ID from EEPROM and transmit a special packet of its own. This special packet will include its newly read ID. The test fixture will receive this packet and verify the ID against the one it sent to this unit over the serial interface.

### Software/Firmware

Described below is an example embodiment of a design and working of the firmware embedded into a base unit with the exception of the workings of the embOS Real Tine Operating system. The internal workings of the embOS Real Time operating system is described in the embOS Ref and embOS ARM Ref specifications. The architecture and design of a base unit application (firmware) as discussed below is one example embodiment of the inventive subject matter. The architecture provides the overall breakdown of modules and their higher-level interdependence with one another. The design may provide specifications of the public interfaces and public data for the modules along with their responsibilities. A module, when used in this document, is a group of public interfaces that perform a logical service for the application. It may be coded into a single or multiple source files.

The following coding examples are for illustrative use only and should not be taken as a requirement of their use. The necessity is that the code efficiently fulfills the requirements of the public interfaces.

Acronyms and Abbreviations

The following acronyms and abbreviations are used within the text of this document.

| | |
|---|---|
| ADC | Analog to Digital Converter |
| API | Application Programming Interface |
| ECEF | Earth Centered, Earth Fixed. |
| Flash | A form of non-volatile memory |
| GPS | Global Positioning System |
| LCD | Liquid Crystal Display |
| LED | Light Emitting Diode |
| LLA | Latitude, Longitude, and Altitude |
| SRAM | Static Random Access Memory |

### DEFINITIONS

embOS—A real time operating system available from SEGGER Microcontroller Systeme GmbH. It is a multithreaded single application priority controlled operating system.
ECEF—Earth Centered, Earth Fixed uses three-dimensional XYZ coordinates (in meters) to describe the location of a GPS user or satellite. The origin is at the center of the earth, with the Z-axis piercing the North Pole, and the XY-axis defines the equatorial plane.
IAR Embedded Workbench—An integrated cross development environment for developing software for the ARM processor on Windows based hardware.
RF Module—Radio transceiver module. The base station and each of the collars may contain one of these. The Transceiver may be used to exchange GPS position and control information between the base station and the collars.
JTAG Port—A hardware debugging port supported by the IAR Embedded Workbench. It can also be used to burn the firmware into the flash memory before the debug cycle.
NavMan GPS Receiver—A hardware implementation of a GPS receiver with an onboard processor and software. Communicates through a serial port to the base unit hardware.

Notation and Conventions

Accuracy and tolerance for API parameters and firmware measurements may be within 10% unless otherwise specified.

### REFERENCES

| Reference | Title or Description |
|---|---|
| embOS Ref | embOS Real Time Operating System |
| | Software Version 3.28 CPU independent |
| | User's & Reference manual |
| embOS | embOS Real Time Operating System |
| ARM ref | CPU & Compiler specifics for ARM |
| | core using IAR Embedded Workshop |
| GPS Binary | SiRF Binary Protocol Reference Manual |
| Protocol | |
| NMEA | NMEA Reference Manual |
| Protocol | |
| 3D Compass | Applications of Magnetic Sensors for |
| Ref | Low Cost Compass Systems |
| Sharp CPU | LH75400/01/10/11 System-on-Chip |
| Ref | User's Guide |
| RF Module | RF Module Functional Specification |
| Functional | |
| Spec | |
| RF Module | RF Module Interface Specification |
| Interface | |
| Spec | |

### Application Module Descriptions

FIG. 10 illustrates application modules 1040-1052 of a base unit 1012, along with any algorithms used may be described in the sections below. Base unit 1012 can be, but is not limited to, any of the base units described herein. Some modules are active objects that run in their own thread of execution. As active objects are running asynchronous with one another, collaboration and mailbox mechanisms are used to pass data between these modules.

Those modules that are not active objects, calls to the API are processed synchronously. Note that some of the modules that are active objects may present one or more API calls that are synchronous.

AD Converter

The AD Converter module 1040 is an API used to access the Analog to Digital converter. All access to the ADC may be controlled through the AD Converter module 1040. The AD Converter module 1040 may be implemented using a singleton-coding pattern. The API may serialize the calls to the hardware so that calls from multiple threads of execution will work properly.

The API may implement an over sampling call. The over sampling call may up the ADC control bank to read the same analog line at all 16 of the samplings times. The raw ADC count values may be summed, 2 is added (as rounding), and the sum is then divided by 4. This increases the ADC precision from 10 bits to 12 bits (give or take some noise). While this API call is synchronous, the conversion is interrupt driven. This lessens the load on the CPU by causing the calling thread to be suspended while the conversion is taking place.

It is up to the consumer of this module to make sense of the return data. That is, the data being returned is raw. The caller of the AD Converter API must make the conversion from the raw data to a form more understandable to that module.

The following features may be available according to one or more embodiments of the inventive subject matter:
The AD Converter module 1040 may be implemented using a singleton-coding pattern.
The AD Converter module 1040 API may serialize access to the ADC hardware.
The AD Converter module 1040 API may implement an over sampling call to increase the precision of the ADC from 10 bits to 12 bits. Equation to use

$$[ ( {\sum }_{i}^{16} samples [ i ] ) + 2 ] / 4$$

The over sampling call may suspend until the conversion is complete using an interrupt coding pattern.

Battery Module

The Battery Module 1042 is an active object that monitors the voltage and the charging state of the Lilon battery in the base unit. It may also monitor the AC present state. It may periodically use the AD Converter module 1040 to read the battery voltage and report the results to any registered collaborator. It may be coded using a singleton coding pattern.

The Battery Module 1042 may contain and make available through API calls the state from the last sampling. Each sampling period is made up of 20 programmable interval times. At each of the 20 sampling periods, the state of the battery charge and AC present is checked against those of the saved state. If the state of either of these two have changed, a sampling sequence is started. Otherwise, if 20 sampling periods have expired, again, a sampling sequence is started.

The Battery Module 1042 may make available through an API call, a method to synchronously cause a sampling sequence. The caller is blocked, a sampling sequence is performed, and the caller is resumed. The caller may then use the API to read the results of the sampling sequence.

The battery voltage is sampled across a resistor divider circuit. The AD Converter is set up to use Vcc as the upper reference voltage, and Gnd as the lower reference voltage. This produces 1024 counts across the 3.3V, or 4096 counts across the 3.3V when over sampled.

The following features may be available according to one or more embodiments of the inventive subject matter:
The Battery Module 1042 may be coded using a singleton coding pattern.
Each Battery Module 1042 sampling interval may be made up of 20 sampling periods. The default sampling period may be 1 second.
During each Battery Module 42 sampling period, the AC present status may be sampled. If the AC present status has changed, then a full sampling sequence may be performed.
During each Battery Module 1042 sampling period, the Battery Charging status may be sampled. If the Battery Charging status has changed, then a full sampling sequence may be performed.
The Battery Module 1042 API may provide a method to perform a full sampling sequence synchronously.
The Battery Module 1042 API may provide API methods to retrieve the last sample battery voltage, the AC present status, and the Battery Charging status.
The conversion from the over sampled battery voltage ADC count to actual voltage may use the equation

double(ADCcount)×260÷100×3.3÷4096
The Battery Module 1042 may provide an analyzer to convert the battery voltage into a number from 0 to 15 roughly indicating remaining battery life.

Compass Module

A base unit contains a 3-axis magnetic compass sensor with an accelerometer sensor used to determine the pitch and tilt of the platform. The Compass Module 1044, an active object, may periodically, using the AD Converter Module 1040, measure the raw X/Y/Z magnetic vectors magnitudes, along with the accelerometer pitch and roll magnitudes. The Compass Module 1044 performs the necessary calculations to generate a magnetic vector. The Compass Module 1044 also controls the degauss circuit; the set/reset straps of the magnetic compass sensors.

The Compass Module 1044 is an active object coded using a singleton-coding pattern. It maintains the last sampled state of the magnetic compass and exposes it through its API calls. Also included in the API calls is a method to perform a synchronous compass measurement; methods to perform calibrations; and methods to persist and restore the calibration data.

When the accelerator sensor is in a plane tangential to the earth, the gravitational vector is perpendicular to the pitch and roll axis and should read “center scale”. This center scale reading needs to be calibrated to be zero. This is the only calibration that needs to be applied to the tilt/acceleration sensor.

The following features may be available according to one or more embodiments of the inventive subject matter:
The Compass Module 1044 may provide a calibration method that determines the ADC count offsets of the accelerometer pitch and roll axis when the platform has no tilt or pitch.
The pitch may be calculated by the following equation

φ=a sin((countX−offsetX)/mCount)
where countX is the value read from the AD Converter, offsetX is the corresponding calibration offset and mCount represents the AD Converter count at 1 G which is calculated.
The roll may be calculated by the following equation

θ=a sin((countY−offsetY)/mCount)
where countY is the value read from the AD Converter, offsetY is the corresponding calibration offset and mCount represents the AD Converter count at 1 G which is calculated.

The magnetic sensor can measure the magnitude of the magnetic vector in all 3 axis. To properly convert the AD Converter counts, both the Op Amp reference voltage (Vref) must be measured as must the bridge offset. The bridge offset is measured during the degauss cycle, in between the set and reset pulses. To compensate for soft and hard iron influences, a further offset and scaling of the value measured along each axis is necessary.

The following features may be available according to one or more embodiments of the inventive subject matter:
The Compass Module 1044 may perform a degauss of the magnetic compass bridges once every 10 minutes.
During the degauss cycle, the Compass Module 1044 may read and determine the bridge offsets.
The Compass Module 1044 may provide calibration routines to determine the offsets due to soft and hard iron influence.
During the X/Y/Z calibration, Compass Module 1044 may keep track of the minimum and maximum values of Xcompass−Vref−XbridgeOffset, Ycompass−Vref−YbridgeOffset, and Zcomnpass−Vref−ZbridgeOffset.
The Compass Module 44 may calculate the magnetic compass offsets with the equations (X max−X min)/2−X max, (Y max−Y min)/2−Y max, and (Z max−Z min)/2−Z max

Given the pitch, roll and the magnitude of the magnetic vector in all three axes it is possible to determine the magnetic heading. Due to the inverted placement of the components (placed on the bottom side of the board), the equation differs slightly from the classic form.

The following features may be available according to one or more embodiments of the inventive subject matter:
The Compass Module 1044 may correct the magnetic vector magnitude values, read with the AD Converter, using the following equations,

xRaw=(Xvalite−Vref−XbridgeOffset+Xoffset)*Xscale,

yRaw=(Yvalue−Vref−YbridgeOffset−Yoffset)*Yscale, and

zRaw=(Zvalue−Vref−ZbridgeOffset+Zoffset)*Zscale
The Compass Module 1044 may use the following equations to determine the magnetic heading of the unit.

x=xRaw*cos(φ)+yRaw*sin(θ)*sin(φ)+zRaw*cos(θ)*sin(φ),

y=yRaw*cos(θ)−zRaw*sin(θ), and heading=a tan 2(y,x)*180/π
The Compass Module 1044 may perform sampling of the magnetic and accelerometer sensors at a rate of 1 complete sample each 1 second and convert those reading to a magnetic heading.
The Compass Module 1044 API may make available the last measured magnetic heading.

GPS Module

The purpose of the GPS Module 1046 code is to initialize the NavMan GPS receiver, receive and process sentences from it. The NavMan GPS receiver can send sentences in either a binary protocol or the more standard NMEA ASCII protocol. The GPS Module 1046 may setup the NavMan GPS Receiver to use the NMEA ASCII protocol.

The GPS Module 1046 may provide methods for the decoding of the NMEA sentences for GPS position ($GPGGA) and GPS velocity ($GPVTG). Additionally, the GPS Module 1046 may keep the last received and last valid decoded GPS position and the last received and last valid decoded GPS velocity data.

The GPS Module 1046 may provide API methods to work with distance and headings; and with easting/northing conversions. The equations used to convert the latitude and longitude to a given easting/northing starting at an arbitrary longitude are given in the figures below.

The following features may be available according to one or more embodiments of the inventive subject matter:
The GPS Module 1046 may be coded as a singleton active object with a collaborative mechanism.
The GPS Module 1046 may initialize the NavMan GPS module to return NMEA $GPGGA and $GPVTG sentences at a desired rate.
The GPS Module 1046 API may provide methods to decode the NMEA $GPGGA and $GPVTG sentences.
The GPS Module 1046 may contain API methods to convert latitude and longitude into easting/northing values using the equations in Equations Sets 1, 2, 3.
The GPS Module 1046 API may provide the last measured GPS position and the last measured valid GPS position.
The GPS Module 1046 API may provide the last measured velocity and heading reading in addition to the last measured valid velocity and heading reading.

$$\begin{matrix} Equations for Easting \text{/} Northing Part 1 & \\ a = 6378137 \\ b = 6356752.3142 \\ f = \frac{a - b}{b} \\ {k}_{0} = 0.9996 \\ e = \sqrt{1 - \frac{{b}^{2}}{{a}^{2}}} \\ {e}^{′2} = {( \frac{ea}{b} )}^{2} = \frac{{e}^{2}}{1 - {e}^{2}} \\ n = \frac{a - b}{a + b} \\ φ = \frac{a ( 1 - {e}^{2} )}{{( 1 - {e}^{2} {sin}^{2} ( lat ) )}^{\frac{3}{2}}} \\ ν = \frac{a}{{( 1 - {e}^{2} {sin}^{2} ( lat ) )}^{\frac{1}{2}}} \\ p = ( long - {long}_{0} ) \\ sin {1}^{″} ≅ \frac{π}{180 ⋆ 60 ⋆ 60} & Equation Set 1 \\ Equations for Easting \text{/} Northing Part 2 & \\ {A}^{′} ≅ a [ 1 - n + \frac{5}{4} ( {n}^{2} - {n}^{3} ) = \frac{81}{64} ( {n}^{4} - {n}^{5} ) ] \\ {B}^{′} ≅ \frac{3 an}{2} [ 1 - n + \frac{7}{8} ( {n}^{2} - {n}^{3} ) + \frac{55}{64} ( {n}^{4} - {n}^{5} ) ] \\ {C}^{′} ≅ \frac{15 {an}^{2}}{16} [ 1 - n + \frac{3}{4} ( {n}^{2} - {n}^{3} ) ] \\ {D}^{′} ≅ \frac{35 {an}^{3}}{48} [ 1 - n + \frac{11}{16} ( {n}^{2} - {n}^{3} ) ] \\ {E}^{′} ≅ \frac{315 {an}^{4}}{51} [ 1 - n ] \\ S = {A}^{′} lat - {B}^{′} sin ( 2 lat ) + {C}^{′} sin ( 4 lat ) - {D}^{′} sin ( 6 lat ) + {E}^{′} sin ( 8 lat ) & Equation Set 2 \\ Equations for Easting \text{/} Northing Part 3 & \\ {K}^{′} = {Sk}_{0} \\ {K}^{″} = \frac{\begin{matrix}{{k}_{0} ( sin {1}^{″} )}^{2} \\ ν sin ( lat ) cos ( lat )\end{matrix}}{2} \\ {K}^{′′′} = [ \frac{\begin{matrix}{{k}_{0} ( sin {1}^{″} )}^{4} \\ ν sin ( lat ) {cos}^{3} ( lat )\end{matrix}}{24} ] [ \begin{matrix}5 - {tan}^{2} ( lat ) + \\ 9 {e}^{′2} {cos}^{2} ( lat ) + \\ 4 {e}^{′4} {cos}^{4} ( lat )\end{matrix} ] \\ {K}^{′′′′} = {k}_{0} sin {1}^{″} νcos ( lat ) \\ {K}^{′′′′′} = ( \frac{\begin{matrix}{{k}_{0} ( sin {1}^{′′′} )}^{3} \\ {νcos}^{3} ( lat )\end{matrix}}{6} ) [ \begin{matrix}1 - {tan}^{2} ( lat ) + \\ {e}^{′2} {cos}^{2} ( lat )\end{matrix} ] \\ y = northing = {K}^{′} + {K}^{″} {p}^{2} + {K}^{′′′} {p}^{4} \\ x = easting = {K}^{′′′′} 4 p + {K}^{′′′′′} {p}^{3} & Equation Set 3\end{matrix}$$

The GPS Module 1046 API may provide methods of converting ECEF coordinates into longitude and latitude coordinates

LCD Module

The LCD module 1048 is responsible for the placement of data onto the LCD screen hardware. It is also used to drive the backlighting of the LCD hardware. The hardware implements the LCD hardware as a simple frame buffer device. The hardware supports either a 12 bit direct color, or an 8 bit palletized color model.

The following features may be available according to one or more embodiments of the inventive subject matter:
The LCD Module 1048 may be coding using a singleton pattern.
The LCD Module 1048 may provide API methods to control the LCD backlighting hardware.

The Base Unit may use the 8 bit palletized color model with a single fixed pallet loaded into the CPU onboard pallet RAM. The CPU also has a single DMA channel that can handle memory-to-memory data transfer. This makes it possible to use a off screen frame buffer to draw on, then use the DMA to transfer the contents into the LCD frame buffer. This may make the drawing look smoother. Additionally, the DMA channel can be used to quickly clear the frame buffer to a single pallet value.

The following features may be available according to one or more embodiments of the inventive subject matter:
The LCD Module 1048 may run the LCD hardware in 8 bit palletized color mode.
The LCD Module 1048 may provide a single global color pallet.
The LCD Module 1048 API may provide methods to move data from an off screen frame buffer to the on screen frame buffer using hardware DMA.
The LCD Module 1048 API may provide methods to fill a frame buffer with a single pallet color using hardware DMA.

All drawing, whether it is graphics or text, requires a graphics context. This graphics context contains information about background colors, foreground colors, currently selected font, clipping region, raster operation, etc

The graphics operations may include the ability to draw lines, rectangles, ellipses, and bitmaps. The text operations allow the drawing of a single character or a string of characters.

The following features may be available according to one or more embodiments of the inventive subject matter:
The LCD Module 1048 API may provide methods that perform drawing of lines, rectangles, ellipses, and bitmaps.
The LCD Module 1048 API may provide methods that perform drawing of single characters along with strings of characters.
The LCD Module 1048 API may provide multiple font sizes.

RF Module

The RF Module 1050 is used to communicate with the RF Radio hardware. All communications from the Base Unit to the RF Radio is through a serial UART port. Communications with the RF Radio hardware is with any desired protocol.

The RF Radio keeps in contact with a number of remote (collar) units that have been enrolled. The enrolling process is used to pair a remote collar unit with a single Base Unit. Once enrolled, the remote collar unit may communicate its GPS position to the Base Unit.

The RF Module 1050 API may provide methods of converting the ECEF coordinates returned by the remote collar unit into casting and northing numbers.

Sound Module

The Sound Module 1052 is used to drive the speaker in the base unit. The speaker is hooked up to one of the counter outputs through an amplifier circuit. The amount of amplification is controlled through a digital potentiometer. The Sound Module 1052 provides API methods to set the volume, play a single tone, or play multiple tones.

The following features may be available according to one or more embodiments of the inventive subject matter:
The Sound Module 1052 may be coded using an active object and singleton coding patterns.
The Sound Module 1052 may provide API methods to asynchronously play a single or multiple tones.
The Sound Module 1052 may provide an API method to control the volume of the sound.

In various embodiments, a dead reckoning module 1054 is included in a base unit. In various embodiments, the dead reckoning module 1054 includes various sensors operable to allow tracking of animals walking on four feet, such as but not limited to a dog. In various embodiments, the various sensors include gyros, accelerometers, and magnetic sensors, the magnetic sensors operable to determine variation in the earth's magnetic fields.

FIGS. 12A and 12B illustrate various embodiments of a collar 1200. In various embodiments, collar 1200 includes an antenna for a GPS unit and a radio frequency transmitter all in a single unit 1202. In various embodiments, collar 1200 includes a battery pack 1204. In various embodiments, collar 1200 includes a sensor 1212, such as a Hall effect switch, to indicate to the unit 1202 that the collar may have fallen off the subject being tracked.

In various embodiments, the collar 1200 can form a collar having a circumference of between 12 and 28 inches, and is waterproof, vibration and shock proof. In various embodiments, positional tracking accuracy of the system including collar 1200 is 2 meters.

FIG. 13 illustrates embodiments of a radio frequency antenna that can be used on unit 1202. In various embodiments, radio frequency antenna 1300 incuses a length of an antenna element, such as a wire looped back an forth to from a flexible antenna 1302. In various embodiments, antenna 1300 includes a additional length 1304. In various embodiment, the length of the element forming antenna 1302 is no more than 37 inches. In various embodiments, the length of additional section 1304 is no more than 8 inches.

It has been observed that when a radio antenna is located in close proximity the living tissue, such as would be included in an animals neck, or a child's wrist or waist, there is a loading effect that occurs on the signals being transmitted from the radio antenna. The amount to which the transmitted signals are affect by the antenna being in close proximity to the living tissue is a function of the frequency to the signals being transmitted wherein certain frequencies are more detrimentally affected by the proximity than other frequencies.

In various embodiments, antenna 1300 is located in adjacent proximity and flexed along a collar, such as collar 1200 as shown in FIGS. 12A and 12B. In such embodiments, any signals transmitted from the antenna, if in particular frequency range or ranges, are affected by the living tissue that is in close proximity to the collar when the collar is installed on a dog, or when installed on a child in the form of a wrist band or a belt. In order to compensate for these effects of living tissue, in various embodiments, devices are coupled to the antenna that tune the transmission circuit inkling the antenna to in order to maximize the performance of the transmissions from the antenna when in close proximity to the living tissue.

In various embodiments, the tuning includes coupling a capacitor, such as capacity 1307 as shown in FIG. 13, to the antenna. The capacitance value for the capacitor is chosen to optimize transmission performance, including maximizing transmitted power at the antenna when operated in close proximity to the living tissue. In various embodiments, tuning includes coupling an inductor having an inductance value to the antenna. The inductance of the inductance is chosen to optimize transmission performance, including maximizing transmitted power at the antenna when operated in close proximity to the living tissue. Embodiments are not limited to using one device, or any particular type of device to perform the tuning function, and in various embodiments includes a combination of device.

In various embodiments, a value or values for one or more components used for tuning the antenna and the circuit driving the antenna during signal transmissions is determined empirically by simulating the living tissue of animal using a water and saline solution, placing the antenna and driver circuit in close proximity of the water and saline solution, and then testing different values of the components, such as a capacitor or an inductor, to determine which value for a single component, or which values if multiple components are being used, provides the optimized performance for the transmission and antenna circuit

Embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of skill in the art upon reviewing the above description.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

We claim:

1. A system comprising:
a remote unit operable to determine a geographic location of the remote unit, and to transmit data indicating the location of the remote unit, the remote unit coupled to a subject to be tracked, the remote unit operable to provide a stimulation to the subject; and
a base unit operable receive the data indication the location of the remote unit, to determine if the remote unit is within a defined perimeter, and to signal the remote unit to provide the stimulation to the subject if the remote unit is not within the defined perimeter.

2. A system comprising:
a portable remote unit including a dead reckoning unit, the dead reckoning unit operable to provide a locational fix for the portable remote unit based on data inputs associated with movements of the portable remote unit, the portable remote unit operable to transmit data indicative of the locational fix;
a base unit operable to receive the data indication of the locational fix and to display a visual indication of the locational fix based on the received data.

3. A positional monitoring system including:
a server coupled to a network, the sever operable to receive positional information over the network, the positional information related to at least one remote unit; and
a plurality of locational regions, each locational region including at least one base unit, each of the at least one base units operable to receive positional information signals from the least one remote unit, and to transmit the positional information over the network to the server.
